(19) United States
(12) Patent Application Publication
(10) Pub. No.: US 2006/0244757 A1
(43) Pub. Date: Nov. 2, 2006

(54) Methods and systems for image modification

(75) Inventors: Hui Fang, Champaign, IL (US); John C. Hart, Champaign, IL (US)

Correspondence Address: GREER, BURNS & CRAIN, 300 S WACKER DR, 25TH FLOOR, CHICAGO, IL, 60606, US

(73) Assignee: The Board of Trustees of the University of Illinois

(21) Appl. No.: 11/395,545

(22) Filed: Mar. 31, 2006

Related U.S. Application Data
(63) Continuation-in-part of application No. 10/899,268, filed on Jul. 26, 2004.

(51) Int. Cl. G09G 5/00

(52) U.S. Cl. 345/582

(57) ABSTRACT

A method for modifying an image includes the steps of selecting at least a portion of the image on which to superimpose a texture and segmenting the at least a portion of the image into a plurality of clusters. Each of the clusters is then parameterized with texture coordinates, and texture is assigned to each of the clusters using the texture coordinates to result in a texture patch. The texture patches are then blended together. As a result of practice of this method, the texture patches appear to adopt the surface undulations of the underlying surface.

### CROSS REFERENCE

The present application is a continuation-in-part of co-pending U.S. patent application Ser. No. 10/899,268 filed on Jul. 26, 2004, which application is incorporated by reference.

### STATEMENT OF GOVERNMENT INTEREST

This invention was made with Government assistance under National Science Foundation Grant No. ACI-0121288 UFAS No. 1-5-29322. The government has certain rights in the invention.

### FIELD OF THE INVENTION

The present invention is related to systems and methods for modifying images, with systems, program products and methods for modifying a sequence of image frames being examples.

### BACKGROUND OF THE INVENTION

The availability of powerful computer processors at relatively low prices has resulted in recent methods and systems for processing and manipulating images such as photographs. Computer program-based editing tools are available, for example, that allow two-dimensional images including photographs to be manipulated or edited. Images may be cropped, rotated, skewed in one or more directions, colored or un-colored, and the brightness changed, to name some of the example manipulations that can be made. Images may also be “cut and pasted,” wherein a selected portion of one image is superimposed over a selected portion of a second image. Another known method is so-called “in-painting,” in which an image is extended across regions that have been left blank after removing an unwanted object. Image in-painting typically draws the samples to be filled into blank regions of an image from another portion of the image, and solves a system of partial differential equations to naturally merge the result.

It is also known to analyze a two-dimensional representation of a three dimensional surface to obtain attributes of the three-dimensional surface. For example, so called “shape from shading” methods are known for reconstructing a three-dimensional surface based on the shading found in a two dimensional representation of the original surface. Generally, shape from shading methods recreate a surface by assuming that bright regions of the two-dimensional representation face toward a light source and darker regions face perpendicular or “away” from the light source. Thus a per-region surface normal can be estimated. Reconstruction of a surface from these recovered per-region surface normals, however, can lead to inconsistencies. Shape from shading methods are therefore most often presented in an optimization framework wherein differential equations are solved to recover the surface whose normals most closely match those estimated from the image.

So-called “texture synthesis” is also known, wherein a two-dimensional texture sample is used to generate multiple new, non-repetitive texture samples that can be patched together. By way of example, a photograph of a small portion of a grass lawn can be used to generate a much larger image of the lawn through texture synthesis. Instead of simply repeating the small sample image, texture synthesis can employ a machine learning or similar technique to “grow” a texture matching the characteristics of the original. Each newly “grown” pixel in the synthesized texture compares its neighborhood of previously “grown” pixels in the synthesized texture with regions in the original texture. When a matching neighborhood is found, the newly grown pixel's color is taken from the corresponding pixel in the matching neighborhood in the original texture. Examples of texture synthesis methods include “Pyramid-Based texture analysis/synthesis,” by Heeger et al., Proceedings of SIGGRAPH 95 (1995) 229-238; “Multiresolution sampling procedure for analysis and synthesis of texture images,” by DeBonnet, Proceedings of SIGGRAPH 97 (1997) 361-368; and “Synthesizing natural textures,” by Ashikhmin, 2001 ACM Symposium of Interactive 3D Graphics (2001), all of which are incorporated herein by reference.

Recent texture synthesis work includes “Image Quilting for Texture Synthesis and Transfer,” by Alexei A. Efros and Willian T. Freeman Proc. SIGGRAPH (2001) and “Graphcut textures: Image and video synthesis using graph cuts”, by Kwatra, V. et al. Proc. SIGGRAPH (2003) (“the Graphcut reference”), also incorporated herein by reference. These methods generally find seams along which to cut to merge neighboring texture swatches so the transition from one swatch to another appears realistic (e.g., the seam falls along the boundary of texture features). Texture synthesis can be applied to surfaces if there is already a 3-dimensional representation of the surface, with one example method for doing so disclosed in “Texture Synthesis on Surfaces” by Greg Turk, Proc. SIGGRAPH (2001), and “Texture Synthesis over Arbitrary Manifold Surfaces” by Li Yi Wei and Marc Levoy, Proc. SIGGRAPH (2001).

Most recently, the present inventors invented novel methods and systems for modifying an image, with one example of the methods including steps of segmenting an image into clusters, parameterizing each cluster with coordinates, and using the coordinates to create a texture patch for the cluster. The texture patches are then blended together. As a result, the texture patches appear to adopt the surface undulations of the underlying surface. These novel methods and systems are disclosed in co-pending U.S. patent application Ser. No. 10/899,268; which is incorporated by reference herein, and which the present application is a continuation in part of.

Still other problems in the art are related to modifying temporal sequences of images, with an example being motion pictures such as video. Since Walt Disney's “Snow White,” rotoscoping has allowed animators to capture the fluid motion of live-action video sequences but with the appearance of a cartoon by manually overpainting the recorded motion with animated characters. Since then, other motion capture tools have been developed that record the motion of an articulated figure (ranging from the poses of a body to the expressions of a face) so it can be reproduced with an altered appearance, as demonstrated in modern form by the 2004 movie “The Polar Express.” This altered appearance can range from complete replacement by an animated figure to augmentation of the recorded appearance, and the latter can be as simple as changing the perceived color to apply a texture signal to a surface depicted in a video sequence.

The ability to synthesize a texture or apply a texture image to a video sequence provides an alternative to the expensive, time consuming and uncomfortable special effects make-up that is common in science fiction and horror productions. Surface textures can also be applied to the video depiction of clothing, objects and buildings to customize their appearance without the expense of constructing the texture material physically. Dynamic objects depicted in the video, however, such as moving surfaces, pose a challenging reconstruction problem. Many currently known methods for extracting the geometry and motion from a video sequence to support its retexturing require calibration, multiple cameras and/or structured light.

One example of a known method for modifying a temporal sequence of images is an optical flow method. Such a method matches sparse features between two video frames and interpolate this matching into a smooth dense vector field. Optical flow methods are not yet accurate enough to be able to deform the color signal produced by a texture synthesized or mapped in the first frame to frames in the remainder of a sequence.

### SUMMARY OF THE INVENTION

A method for modifying an image includes the steps of selecting at least a portion of the image on which to superimpose a texture and segmenting the at least a portion of the image into a plurality of clusters. Each of the clusters is then parameterized with texture coordinates, and texture is assigned to each of the clusters using the texture coordinates to result in a texture patch. The texture patches are then blended together. As a result of practice of this method, the texture patches appear to adopt the surface undulations of the underlying surface.

Still an additional method of the invention is directed to modifying a sequence of a plurality of frames depicting a surface. One example method comprises steps of selecting at least one key frame from the plurality of frames, and segmenting the surface in the at least one key frame into a plurality of units. A surface orientation of each of the units in each of the at least one key frames is estimated, and units in each of the at least one key frame are assembled into a plurality of groupings. The surface orientation of the units is used to parameterize each of the groupings with an auxiliary coordinate system. Steps of propagating the groupings and the auxiliary coordinate system from the at least one key frame to others of the plurality of frames are performed whereby the auxiliary coordinate system models movement of the surface in a time coherent manner between frames. The auxiliary coordinate system in each of the groupings in each of the frames is used to superimpose a texture on the surface whereby the texture appears to change temporally consistently with the surface between the plurality of frames.

### BRIEF DESCRIPTION OF THE FIGURES

FIG. 1 is a flowchart illustrating an exemplary method for modifying a two-dimensional image;

FIG. 2A-2E illustrate the results of practice of various steps of an exemplary method of the invention on a photograph of a statue of a lion;

FIG. 3 is a schematic useful to illustrate steps of parameterizing a cluster with texture coordinates;

FIG. 4 is useful to illustrate an exemplary step of patch deformation;

FIG. 5 is useful to illustrate a step of performing a displacement mapping;

FIG. 6 illustrates the results of practice of an additional method of the invention useful to emboss an image with the surface undulations of another image;

FIG. 7 illustrates the results of practice of a method of the invention on manually generated images;

FIG. 8 is a flowchart of a method of the invention useful to modify a sequence of images;

FIG. 9 is a flowchart of an additional method of the invention useful to modify a sequence of images;

FIG. 10 is a useful to illustrate practice of a texture mapping embodiment of the invention;

FIG. 11 is a flowchart of an additional method of the invention useful to modify a sequence of images;

FIG. 12 is useful to illustrate steps of advecting a cluster using optical flow;

FIG. 13 is useful to illustrate steps of advecting texture parameterization on the boundary of a cluster using optical flow;

FIG. 14 is useful to illustrate example steps of building an MAT;

FIG. 15 is useful to further illustrate advection using MAT;

FIG. 16 illustrates the results of practice of a method of the invention on the statue illustrated in FIG. 15; and,

FIG. 17 is useful to illustrate practice of a texture synthesis embodiment of the invention.

### DETAILED DESCRIPTION

The present invention includes methods, systems and program products for modifying individual images as well as sequences of image frames (e.g., a motion picture or video). Before discussing various embodiments of the invention in detail, it will be appreciated that some embodiments of the present invention lend themselves well to practice in the form of a computer program product. It will further be appreciated that a method of the invention may be carried out by one or more computers that may be executing a computer program product of the invention, and that may thereby comprise a system of the invention. A computer program product of the invention, for example, may comprise computer readable instructions stored on a computer readable medium that when executed by one or more computers cause the computer(s) to carry out steps of the invention. In discussing various embodiments of the invention, then, it will be appreciated that discussion of a method of the invention may likewise be description of a computer program product and/or a system of the invention.

A. Method for Modifying an Image

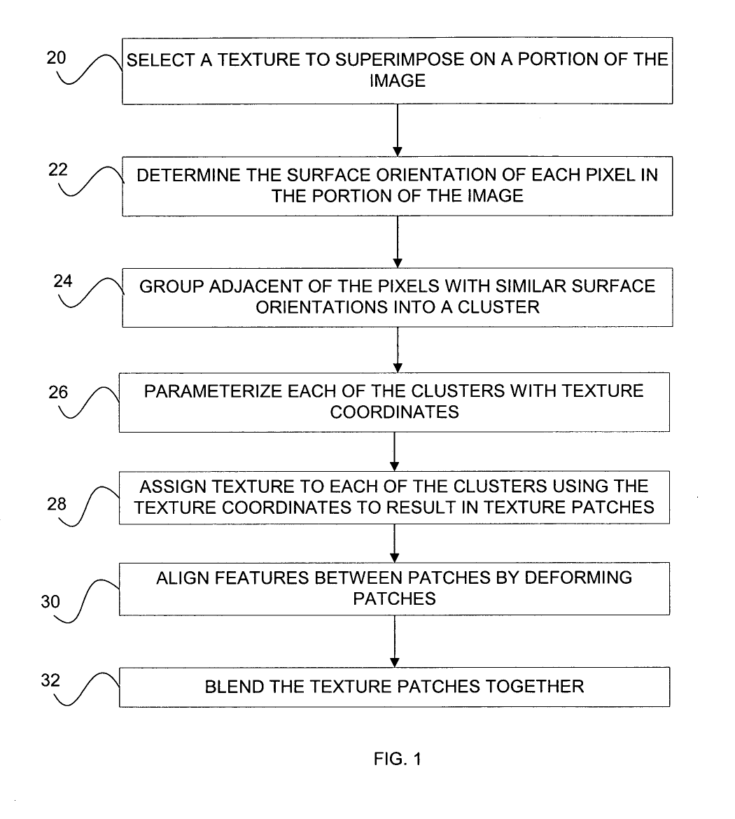

Turning now to the drawings, FIG. 1 is a flowchart illustrating one example of a method for modifying a two-dimensional image of a three-dimensional surface. As used herein, the term “three dimensional surface” is intended to broadly refer to any three-dimensional phenomenon that when projected onto a 2-dimensional field of radiance samples (e.g., image pixels), conveys adequate information from which the corresponding per-sample orientation can be estimated. One example is a 2-dimensional photograph of a 3-dimensional Lambertian (diffuse) 2-manifold surface. A texture is selected to superimpose on a portion of the image (block 20). As used herein, the term “texture” is intended to broadly refer to any synthesized or stored sequence of image regions or portions. For example, a texture may be a photograph (possibly manipulated) or the result of a stochastic process. Specific examples of textures include, but are not limited to, an image of an object, a two-dimensional pattern of objects such as grass, bricks, sand, cars, faces, animals, buildings, etc.

In an example embodiment of the invention, the image on which the method is practiced is defined by a multiplicity of individual units, which in the example of a digital photograph or image may be pixels or groups of pixels. The example method includes a step of determining the surface normal of each individual unit (pixel in the case of a digital image) of the portion of the image on which the texture is to be superimposed (block 22). Although different steps are contemplated for determining the surface normal, a preferred method is to use the shading of the individual units or pixels. For example, shading can be indicative of orientation to a light source and hence can be used to estimate a surface normal. The portion of the image is then segmented by grouping together adjacent pixels having similar surface normals into clusters (block 24). Other methods for segmenting pixels into clusters are also contemplated with examples including use of color or location.

Once the pixels have been segmented into clusters, the clusters are individually parameterized with texture coordinates. (block 26) As used herein, the term “parameterize” is intended to broadly refer to mapping surface undulations in a two dimensional coordinate system. For example, parameterizing may include assigning coordinates to each image pixel to facilitate the realistic assignment of texture. Parameterizing may thereby include capturing the 3-dimensional location of points projected to individual pixels of the image, and assigning a 2-dimensional texture coordinate representation to the surface passing through these 3-dimensional points. The resulting 2-dimensional texture coordinates may also be referred to as an image distortion since each 2-dimensional pixel is ultimately assigned a 2-dimensional texture coordinate.

Through parameterization, the texture coordinate assigned to each individual unit or pixel in each cluster captures the projection of the 3-dimensional coordinate onto the image plane, and indicates the surface coordinates per-pixel. This allows for the distance traveled along the surface as one moves from pixel to pixel in the cluster to be measured. For example, the latitude and longitude coordinates of the earth can be considered a texture coordinate (u,v) (i.e., u=latitude, v=longitude) and an image of the earth taken from space would have for each pixel in the disk of the earth's projection assigned its latitude and longitude as its surface texture coordinates. As one traveled from the center of this image toward the edge of the disk in one-pixel units, the change in (u,v) (i.e., latitude, longitude) would increase. Parameterization may also include a per-patch rotation such that the texture “grain” (anisotropic feature) follows a realistic direction. The direction to be followed may be input by a user or otherwise determined. Thus the step of parameterizing into texture coordinates captures the estimated undulation of the photographed surface.

Texture is then assigned to the cluster using the texture coordinates to create a texture patch for each cluster. (block 28) Those knowledgeable in the art will appreciate that there are many suitable steps for assigning texture values to the pixels. By way of example, patches may simply be cut from a larger texture swatch, or a single patch may be cut and be repeatedly duplicated. More preferably, a texture synthesis process is used to generate non-repeating patches that provide a more realistic final visual appearance.

In some applications, a step of aligning features between texture patches may be performed to bring features into alignment with one another for a more realistic and continuous appearance. (block 30) This feature matching may be performed, for example, by deforming the patches through an optimization process that seeks to match the pixels in neighboring patches.

The texture patches are then blended together. (block 32) As used herein, the term “blended” is intended to be broadly interpreted as being at least partially combined so that a line of demarcation separating the two is visually plausible as coming from the same material. Once blended, the texture patches appear to form a single, continuous texture swatch that adopts the surface undulations of the underlying portion of the image. Methods of the invention thereby offer a convenient, effective, and elegant tool for modifying a two-dimensional image.

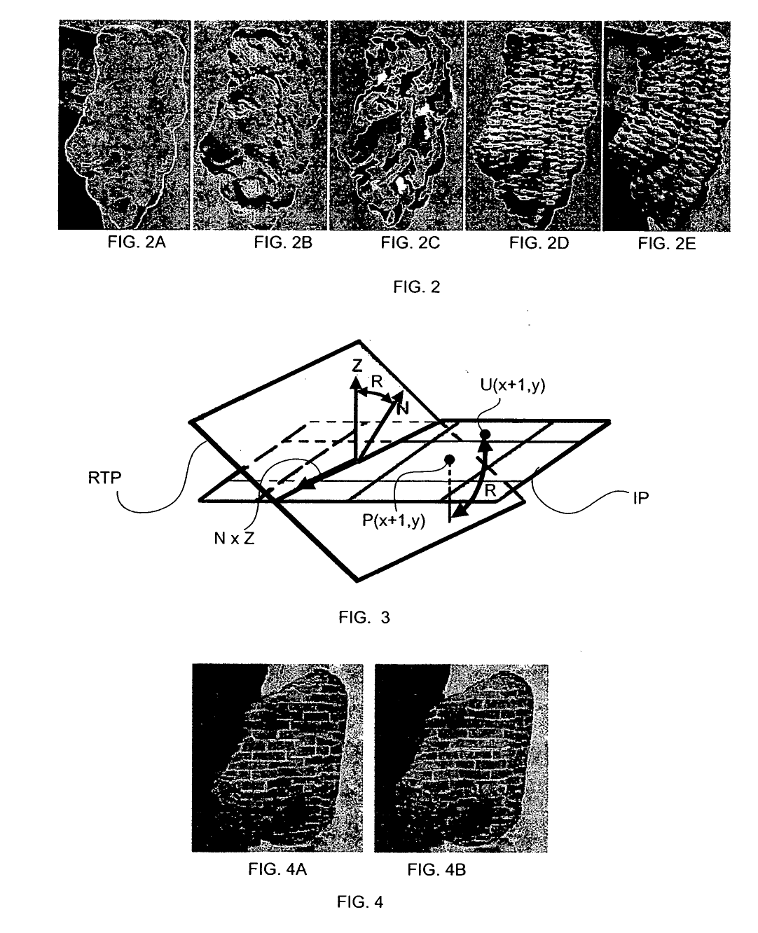

Having now presented one example embodiment of a method for modifying a two-dimensional image, an additional example method and its steps may be described in greater detail with reference to a two-dimensional image of a three dimensional surface. FIG. 2A is a two-dimensional image of a three-dimensional surface; namely a photograph of a statue of a lion. In a step of a method of the invention, the portion of FIG. 2A showing the lion's face (outlined with a white line in FIG. 2A) is selected for superimposing a texture on, and a wicker is selected as the source texture. (FIG. 1, block 20)

The surface normal of each pixel is then obtained for the portion of the image showing the lion's face, preferably through a shape from shading technique. (FIG. 1, block 22) The obtained surface normals will then be used to segment the selected portion of the lion's face into clusters. Artisans will appreciate that several methods are available for determining surface normals from an image, with examples disclosed in “Height and gradient from shading,” by Horn, International Journal of Computer Vision, 5:1, 37-75, (1990); herein incorporated by reference.

A preferred step for estimating surface normals that has been discovered to offer useful accuracy in addition to relative computational speed and ease is use of a Lambertian reflectance model. In one such model, S is the unit vector from the center of each pixel toward a sufficiently distant point light source. It is assumed that the pixel having the largest light intensity Iₘₐₓ (the brightest point) faces the light source, and the pixel having the lowest intensity (the darkest point) is shadowed and its intensity Iₘᵢₙ indicates the ambient light in the scene. The function

$$c ( x , y ) = \frac{( I ( x , y ) - {I}_{min} )}{( {I}_{max} - {I}_{min} )}$$

can be used to estimate the cosine of the angle of light incidence, and
s(x,y)=\sqrt{1−c(x,y)²}
can be used to estimate its sine. These estimates lead to the recovered normal N(x, y):

$$G ( x , y ) = ∇ I ( x , y ) - ∇ I ( ( x , y ) \cdot S ) S$$

$$N ( x , y ) = c ( x , y ) S + \frac{s ( x , y ) G ( x , y )}{‖ G ( x , y ) ‖}$$

$$where$$

$$∇ I ( x , y ) = ( \frac{\partial I}{\partial x} , \frac{\partial I}{\partial y} , 0 )$$

is the image gradient.

The exemplary steps next estimate the vector to the light S from the intensity of pixels (xᵢ,yᵢ) on the boundary of the object's projection. For such pixels the normal N(xᵢ,yᵢ) is in the direction of the strong edge gradient. The source vector S is then the least-squares solution to the overconstrained linear system:
N(x,y)·S=(I(x,y)−Iₘᵢₙ)/(Iₘₐₓ−Iₘᵢₙ).

Practice of these sample steps can be further illustrated by consideration of FIG. 2B showing estimated surface normals as small black lines. It will be appreciated that these steps assume a single light source. Other embodiments of the invention contemplate multiple light sources, and may include additional steps of a user adjusting the light source direction manually if the inferred result is incorrect. For example, a method of the invention may be practiced interactively on a computer wherein a user views results on a screen and can dynamically alter the light source location to change results. Iterative adjustment may be performed until a suitable image is obtained.

The normal field thus estimated may not be as accurate as normals estimated through more rigorous analysis. While other methods of the invention can be practiced using more rigorous models, it has been discovered that these example steps that utilize a Lambertian reflectance model provide a useful level of accuracy to capture the undulations of a surface well enough for practice of the invention. Also, these example steps achieve advantages and benefits related to computational speed and ease. These steps have been discovered to be suitably fast, for example, to be used in an interactive photograph computer program product on a typically equipped consumer computer.

In an additional step of this example method, the surface pixels are grouped or segmented into clusters with similar normal directions using a bottom-up scheme in which a relatively large collection of small units is merged into a smaller collection of larger elements. (FIG. 1, block 24) Generally, adjacent pixels having similar normal directions will be joined together into a cluster. Depending on factors such as the size of the cluster and the severity of the underlying surface undulations, the clusters may have a generally uniform orientation or may have significant surface undulations. Artisans will appreciate that different steps and standards will be useful for establishing that two adjacent pixels have “similar” normals. By way of example, two unit-length normals may be compared using their dot product, which ranges from −1 to 1 and indicates the cosine of the angle between them.

In one example set of steps to cluster adjacent pixels, the segmentation process is initialized by first assigning each pixel to its own cluster. Two adjacent clusters are then merged if an error metric is satisfied, with the error metric including terms related to the size of clusters, the roundness of clusters, and the similarity of normals of pixels within each cluster. In one such error metric, Pᵢ, Nᵢ, Cᵢ and |Pᵢ| denote the cluster's mean normal, centroid pixel and number of pixels, respectively. Two neighboring clusters P₁, P₂ are merged if the error metric
E(P₁,P₂)=k₁(1−N₁·N₂)^{1/2}+k₂∥C₁−C₂∥+k₃(|P₁|+|P₂|)
falls below a given threshold. In this equation, constant k₁ affects the similarity of normals in each cluster, constant k₂ the roundness of the clusters, and k₃ the size of the clusters. Appropriate settings for the constants k₁ k₂ and k₃ will yield moderate-sized round clusters of similarly oriented pixels. Substantially round and relatively small clusters are preferred. In exemplary cases constants of k₁=187, k₂=20, k₃=1 have been useful. By way of example, FIG. 2C shows the clusters having been created according to this error metric and constant values. Those knowledgeable in the art will appreciate that many other constant values, error metrics, and other steps will be appropriate for segmenting into clusters within the practice of the invention.

A preferred step of segmenting into clusters further includes expanding the clusters so that they overlap onto one another to define an overlap region between adjacent clusters. For example, expanding the clusters by a fixed-width boundary, with 8 or 16 pixels being examples, may be performed to define an overlap region between adjacent patches.

Once the pixels have been segmented into clusters, steps of parameterizing with texture coordinates and assigning texture according to the texture coordinates are performed. (FIG. 1, blocks 26 and 28) Parameterizing each cluster can include distorting the clusters by assigning some or all of the pixels P(x,y) in each patch a new position in texture coordinates U(x,y)=(u,v) to capture the foreshortening distortion due to its recovered normal. Suitable steps of parameterizing begin by setting an origin pixel, preferably at the center pixel P(0,0) of a cluster, setting its texture coordinates to U(0,0)=(0,0), and estimating a parametric distortion for all other pixels in the cluster by using the recovered surface normals and propagating outward to the rest of the cluster in a width-first floodfill order.

With reference to FIG. 3, sample steps use P(x,y) to indicate the pixel at (x, y) with distorted position U(x,y) and recovered (unitized) normal N(x,y)=(Nₓ,N_{y},N_{z}). Given P(x,y), exemplary steps compute the foreshortening distortion of the next pixel to its right P(x+1, y) by projecting this pixel's position (x+1,y,0) onto the recovered tangent plane RTP of pixel P(x,y) and then rotating this projection back into the image plane IP, as illustrated in FIG. 3. The distortion is cumulative and propagates by adding the resulting offset to the current distortion U(x,y) and storing the result in U(x+1, y).

The projection of the point (x+1, y, 0) onto the plane with normal N(x, y) passing through (x, y, 0) is (x+1, y, −Nₓ/N_{z}). Let q be the angle between N and Z=(0,0,1) and abbreviate c=cos θ=N_{z}, and s=sin θ=(Nₓ²+N_{y}²)^{1/2}. The unitized axis of rotation is (N×Z)/∥N×Z∥=(N_{y}/s, −Nₓ/s, 0) which leads to the rotation matrix:

$$R = [ \begin{matrix}c + ( 1 - c ) {N}_{y}^{2} / {s}^{2} & - ( 1 - c ) {N}_{x} {N}_{y} / {s}^{2} & - {N}_{x} \\ - ( 1 - c ) {N}_{x} {N}_{y} / {s}^{2} & c + ( 1 - c ) {N}_{x}^{2} {s}^{2} & - {N}_{y} \\ {N}_{x} & {N}_{y} & {N}_{z}\end{matrix} ]$$

The product R(1, 0, −Nₓ/N_{z}) yields the new position of pixel P(x+1, y), leading to the propagation rules:
U(x±1,y)=U(x,y)±(1+N_{z}−N_{y}²,NₓN_{y})/((1+N_{z})N_{z}),
U(x,y±1)=U(x,y)±(NₓN_{y},1+N_{z}−N_{z}²,)/((1+N_{z})N_{z})
It has been discovered that setting a minimum for N_{z} and renormalizing Nₓ and N_{y} is useful to avoid unreasonable results. In exemplary applications, a minimum of about 0.1 for N_{z} has proven useful.

When practicing the example steps of parameterizing, if the distortions of more than one neighboring pixel are available for propagation then the final orientation distortion is the mean of the distortions computed from each of these neighbors. This step of averaging reveals that this scheme can generate an inconsistent parameterization, and that these inconsistencies can increase in severity with distance from the centroid. For this and other reasons, generally small and substantially round texture patches are preferred. These patches reduce the variance of their normals to keep these internal inconsistencies small.

Parameterizing with texture coordinates may also include orienting the texture to more consistently align anisotropic features of the synthesized texture. One suitable orienting step includes rotating patch parameterization about its centroid (conveniently the origin of the parameterization) to align the texture direction vector with the appropriate axis of the texture swatch according to user input. User input may be provided, for example, by specifying a rotation direction through a computer input device such as a keyboard, mouse, or the like when practicing the invention on a computer. By way of particular example, vector field orientation can be modified by dragging a mouse over the image while displayed on a computer screen. The rotation of the parameterization effectively rotates the patch about its average normal. It will be appreciated that orienting the texture patches may also be accomplished without user input, and may be performed on a cluster (i.e., before assigning texture).

In some applications, features may be aligned in the synthesized texture through patch deformation. (FIG. 1, block 30) This may be desirable, for example, to provide additional realism when practicing the invention with textures that include low frequency and easily noticed features. These features may be positioned within the texture patch(es) at locations that result in an unrealistic appearance—they don't realistically align from patch to patch.

One example step of feature aligning through patch deformation is illustrated by FIG. 5, with FIG. 5A showing brick texture patches superimposed on the lions face portion of the statue without patch deformation, and FIG. 5B showing the same image after the patches have been deformed to match features in adjoining patches. Example steps of deforming the patches are discussed in “Textureshop: Texture Synthesis as a Photograph Editing Tool” by Hui Fang and John C. Hart, Proc. SIGGRAPH (2004), incorporated herein by reference.

Artisans will appreciate that many suitable methods are known for aligning texture features within practice of the invention. It has been discovered that a suitable method includes using a deformation algorithm that resembles methods used in smoke animation, which are discussed in detail in “Keyframe control of smoke simulations” by McNamara et al., Proc. SIGGRAPH (2003), incorporated herein by reference. Exemplary steps of aligning the features include utilizing the overlapping region that was defined when the clusters were expanded. The synthesized texture in this overlap region between patches P₁(x,y) and P₂(x,y) is blurred. For each pixel position x=(x,y) in the overlapping boundaries of the patches, a 2-dimensional deformation vector U(x), is defined and initialized to (0,0). An objective function is then defined as:
φ=k₁Σ∥P₁(x)−P₂(x+U(x))∥+k₂Σ|∇·U(x)|
to maximize the color match while minimizing the amount of deformation over the patch overlap region, where the constant k₁ governs color match and k₂ controls the severity of deformation. In an example application, k₁=1, k₂=9, and RGB channels ranged from 0 to 255. The example feature mapping implementation computed ∂/φ/∂U(x) and minimized φ using conjugate gradients. It has been discovered that the deformation vector can be solved on a subset of the overlapping pixels and interpolated on the rest to accelerate convergence and further smooth the deformation, although doing so may have the disadvantage of overlooking the matching of smaller features.

In a subsequent step, the texture patches are blended together (FIG. 1, block 32). Blending helps to camouflage any inconsistencies between patches. The overlap region defined when the clusters were expanded is again utilized. A visually plausible seam within this overlap region is determined, with the patch border then cut along this seam. The term “seam” as used herein in this context is intended to broadly refer to the boundary between two neighboring textured patches. The seam preferably falls along matching portions of texture features, along paths of texture values shared by both neighboring texture patches, such that the transition from one patch's texture to a neighbor's is visually plausible.

One suitable seam optimization that has been discovered to be useful within practice of some invention embodiments is known as “graphcut,” and is described in detail in the Graphcut reference that has been incorporated herein by reference. The graphcut method segments an image into overlapping patches and uses a max-flow algorithm to find a visually plausible path separating the overlapping texture between each pair of neighboring patches. Graphcut texture synthesis creates a new texture by copying irregularly shaped patches from the sample image into the output image.

In the graphcut method, the patch copying process is performed in two stages. First a candidate patch is selected by performing a comparison on the overlapping regions that exists between the candidate patch and the neighboring patches already in the output image. Next, an irregularly shaped portion of this patch interior to the desired seam is computed and only the pixels from this interior portion are copied to the output image. The portion of the patch to copy is determined by using a graphcut algorithm.

The graphcut method seeks to find a visually plausible (i.e., suitably satisfying an optimization) seam at which to cut the patch. A suitable seam location can be computed using an optimization calculation that seeks to optimize (to a suitable degree) the similarity of pixel pairs across the seam after placing the new patch in the synthesized texture. One suitable cost function for cutting a seam through the overlapping region is a weighted combination of pixel color and recovered surface normal, though color alone suffices in many cases. An optimal seam will be the seam that results in the least noticeable difference at the boundary of the patch when joined with existing patches. In the graphcut method, these steps have been formalized in the form of a Markov Random Field. For further details of the graphcut steps for generating non-recurring texture clusters, reference is made to the Graphcut reference that has been incorporated herein by reference.

Those knowledgeable in the art will appreciate that other blending techniques will also be useful, and that sub-optimal seam solution will be acceptable in many cases and may be employed to achieve computational efficiencies and for other reasons. FIG. 2D illustrates the result of having parameterized the lions' head portion of the image, having assigned texture to the texture coordinates generated to result in texture patches, and having blended the patches together.

Example methods of the invention discussed and shown so far have recovered a local surface on which to superimpose a texture swatch. When practicing the invention with some particular textures, it has been discovered that additional steps of performing a displacement mapping on the texture swatch can lead to a more realistic result. That is, the example method steps illustrated have recovered the undulation of an underlying surface and superimposed texture on it. The superimposed texture appears to capture the underlying surface undulations. But the texture itself may be “flat.” For many textures, a flat appearance is realistic and is acceptable. For others, however, additional realism may be achieved by performing a step of displacement mapping. Textures that have a surface with considerable undulations to it are an example, with wicker being one particular example. Displacement mapping takes into account the undulation of the source texture (e.g., the wicker itself). A step of displacement mapping recovers the undulation of the source texture swatch by applying shape from shading to it.

Example steps of performing a displacement mapping include estimating the normals \hat{N}(x,y) of the texture swatch through shape from shading using the same method discussed herein above. But whereas the object surface was reconstructed locally for the portion of the image that the texture is to be superimposed on, the texture swatch will require a global surface reconstruction. In an example set of steps, it is assumed that the input texture color variation is caused only by local normal changes, and accordingly the height field of the texture swatch h(x,y) may be determined by the Poisson equation:
∇²h(x,y)=∇·\hat{N}(x,y)
and solved by conjugate gradients. In a further example method step, the user specifies an origin height of a portion of the texture to create a boundary condition. For example, a shadowed area may be set as an origin or zero height. Features reconstructed using this Poisson equation often shrink or grow when compared to the original. Steps of correcting these inconsistencies may be performed, for example, by interactively correcting through a user-specified nonlinear scale of the height field.

Further steps of translating each texture sample in the direction of the image's recovered normal (Nₓ, N_{y}, 0) by the recovered texture height h(x,y) foreshortened by the recovered texture normal \sqrt{1−\hat{N}_{z}²} can also be performed. To avoid inconsistencies such as holes and otherwise noisy appearance, both the surface normal and texture height may be interpolated and represented at a higher resolution. These displacements may be significant enough to cause aliases when a texture, such as wicker, contains sharp edges. It has been discovered that these artifacts can be sufficiently reduced by blending the edge samples through steps that include, for example, the Painter's algorithm of depth sorting from back to front in which distant objects are rendered before nearer objects which may obscure the distant objects.

FIG. 2E illustrates the results of performing steps of orienting the wicker texture patches and performing a displacement mapping on them. Exemplary steps of applying a displacement mapping and filtering it may be further illustrated by FIG. 5. The image shown in FIG. 5A includes a wicker texture swatch superimposed through a method of the invention without displacement mapping. The smooth silhouette of the swatch may be improved upon through application of a displacement mapping to result in a more realistic appearance. FIG. 5B results from steps of applying a displacement mapping on the swatch after interpolation to a higher resolution texture representation to avoid holes in the output image, but shows a somewhat noisy mapping. The noisiness of the mapping has been removed in FIG. 5C through an antialiasing step of edge filtering. That is, during displacement mapping, the pixels synthesized by the texture are placed in new positions in the destination image. These new locations may not fall exactly on existing destination pixels, but instead in regions between destination pixels. Antialiasing through edge filtering is performed by allowing the nearest destination pixel to take on a portion of the value of the desired displacement-mapped texture.

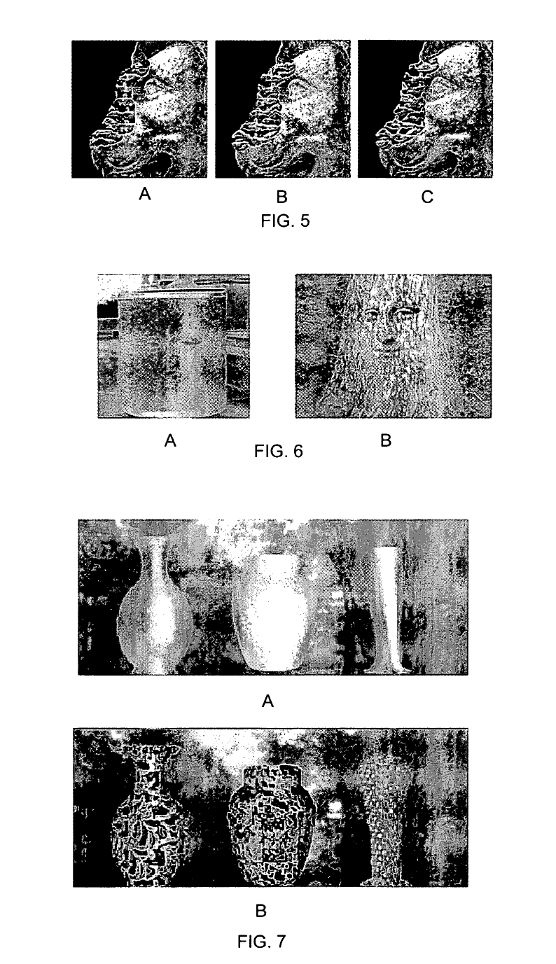

FIG. 6 is useful to illustrate the result of practice of a method of the invention in still another application. An example method for modifying an image consistent with that illustrated in FIG. 1 was practiced, with a few additional steps used. The result of this method of the invention is to modify an image whereby it appears to have been embossed with the surface undulations of a second image. For example, FIG. 6A is an image of a concrete and stone waste container that appears to have the surface undulations of a portion of the famous Mona Lisa face, and FIG. 6B is an image of a tree trunk that similarly appears to have been embossed with the Mona Lisa's surface.

Referring to FIG. 6A, a portion of the image of a concrete and stone waste container was selected as both the texture source and the image over which to superimpose texture onto. (FIG. 1, block 20) The superimposed texture, however, will appear to follow surface undulations of a second image: the face of the famous Mona Lisa painting. The surface normals for each pixel in a selected portion of the stone waste container image are recovered through shape from shading (FIG. 1, block 22).

In an additional step of this embodiment of the invention, the surface normals for the face of the Mona Lisa are then determined using steps consistent with those discussed above with regard to block 22, and these recovered normals are combined with the surface normals recovered from the stone waste container. Those knowledgeable in the art will appreciate that there are a number of methods available for combining the normals. A preferred step includes blending the normals using Poisson image editing which is described in detail in Poisson Image Editing, by Perez, P., et al., SIGGRAPH (2003), incorporated herein by reference.

The pixels of the selected portion of the stone waste container are then segmented into clusters (FIG. 1, block 24) using the blended normals that represent their original normals combined with those transferred from the Mona Lisa. These clusters are then parameterized with texture coordinates (FIG. 1, block 26), and texture from the original stone waste container synthesized on each texture coordinate patch pixel by pixel according to the texture coordinates. (FIG. 1, block 28) The texture patches are deformed (FIG. 1, block 30), and blended together (FIG. 1, block 32).

The result of practice of these steps is shown in FIG. 6A, in which a portion of the concrete waste container appears to have adopted the underlying surface undulations of the Mona Lisa face. The brightness of the portion of the Mona Lisa may likewise be blended into the portion of the stone container image. Referring to FIG. 6A by way of example, this would result in the shading of the Mona Lisa face to appear on the waste container, in addition to the aforementioned visual compression and expansion of texture frequencies due to surface undulation. FIG. 6B illustrates the result when an exemplary method is similarly applied to the Mona Lisa face using an image of a tree as a source texture. In summary, this application of a method of the invention has resulted in a first image appearing to be embossed with the surface undulations of a second image by transferring surface normals from that second image to the first image.

Other methods of the invention may further include steps of manually generating the image to superimpose the texture on. This may be useful, for example to apply texture through an accurate and automated program to a hand-painted or other manually generated image. FIG. 7 is useful to illustrate some example steps. In FIG. 7A, three vases have been manually generated over a background. It will be appreciated that the term “manually generated” is intended to be broadly interpreted as created with some user direction. By way of example, a manually generated image can be drawn by hand using pen, pencil, paint, etc., and scanned into a computer for manipulation. By way of further example, a manually generated image may be drawn on a computer using a computer aided drawing tool or like program.

Practice of a method of the invention consistent with that illustrated in FIG. 1 results in the texture being “painted” on to the vases as shown in FIG. 7B. This can be of great utility in applying texture to manually generated images. Manual shading of such images can be done relatively accurately when they have only a simple, single color and featureless appearance as in FIG. 7A. Realistic application of the texture as shown in FIG. 7B, however, can be a difficult and tedious task if done manually. Use of a method of the invention on the manually shaded images of FIG. 7A eliminates this difficult and tedious task, and results in the realistic texture application of FIG. 7B.

Still another application for methods of the invention such as those shown in FIG. 1 will be with two-dimensional images of a three- dimensional surface generated through an automated tool. For example, computer-based tools are known that can generate a three-dimensional model based on a two-dimensional input. An image of a square or circle can be input to such a tool, for example, and an image of a cube or sphere, respectively, will be output that can be rotated as desired. Practice of the invention may be combined with such a tool, with the three-dimensional model output used as the image onto which texture is superimposed within practice of the invention.

B. Modifying Sequences of Frames

Other aspects of the invention are directed to methods, systems and program products for modifying a sequence of image frames depicting a three dimensional surface, with an example being a motion picture or video of a moving surface. As used in this context, the term “frame” is intended to be broadly interpreted as one image from a sequence of images. For example, motion pictures such as videos and the like consist of a series of sequential images that when shown in sequence can present a realistic depiction of a moving image. Each of these individual images can be described as a “frame.”

These example methods, to at least some extent, can be thought of as an extension of the methods as applied to a single image discussed above in section A. For example, the methods shown and discussed above for modifying an image (e.g., flowchart of FIG. 1) may be practiced on one or a selected portion of each of a sequential series of image frames. The motion of an underlying surface in others of the frames can be estimated. The synthesized texture is then deformed using the estimated motion in these other image frames whereby it appears to match the movements of the underlying surface from image to sequential image.

Accordingly, an additional method of the invention is to apply the method of FIG. 1 to a sequence of image frames in a motion picture, for instance. It has been discovered, however, that in some applications applying this method may result in taxing of available computer resources. Also, in some applications methods such as that illustrated in FIG. 1 when applied to each and every frame in a motion picture can lead to undesirable and inconsistent results, including choppiness and other video noise. To address these and other problems, further methods of the invention have been invented that have been discovered to accurately superimpose a texture on a surface through a sequence of image frames in a realistic manner.

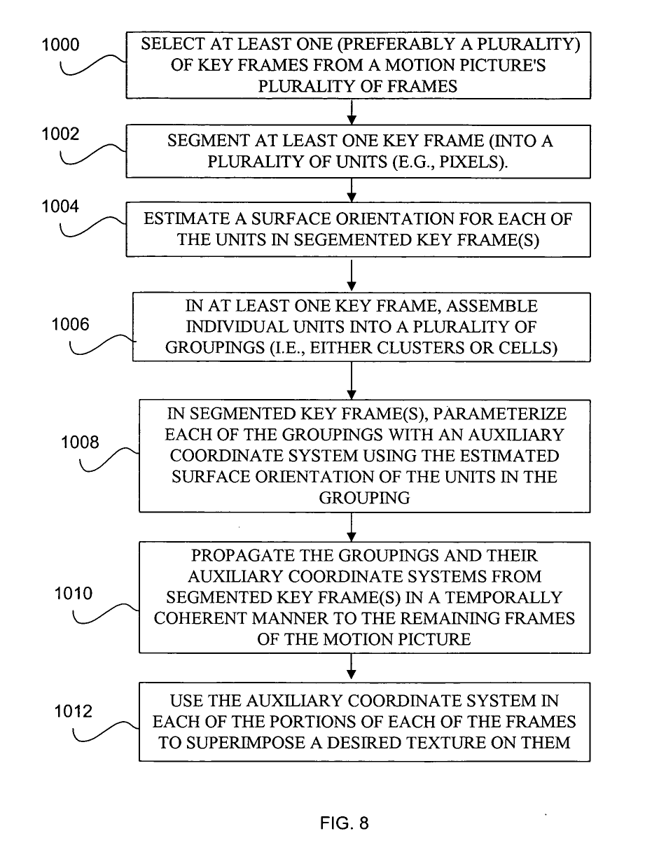

FIG. 8 illustrates one such example method of the invention. In a first step, at least one, and preferably a plurality of key frames are selected from a sequence of frames. (block 1000) By way of example, every third, fifth or tenth frame may be designated as a key frames, with intervening frames between key frames non-key frames. It has been discovered that in some applications advantages may be achieved by applying computationally more complex and expensive operations to only key frames. The selection of key frames will vary with application and factors such as available processor and memory resources, size of image frames, desired accuracy, and the like. Also, it will be appreciated that in some applications all frames may be designated key frames. In other applications, key frames may be spaced from one another by any suitable interval. It has been discovered that a separation of at least four frames.

The key frames are segmented into individual units (block 1002). Example units may be pixels, groups of pixels (e.g., 4 or 16 pixels). In other applications, the key frames may be partitioned into individual units of desired sizes. The surface orientation for each of the units is then estimated. (block 1004) One example method for doing so is using the shading of the units, with an example being through steps of shape from shading to estimate a surface normal for each of the units as discussed in detail herein above (e.g., FIG. 1, block 22 and corresponding discussion). As explained herein above, this method for estimating surface orientation generally assumes that the relative degree of “brightness” of a unit indicates its orientation to a light source: brightly lit units of the image frame face a light source and darker units face away from the source. Estimation of surface orientation may include determination of an estimated surface normal as also discussed in detail above. Other steps for estimating surface orientation are contemplated, and will be apparent to those knowledgeable in the art.

The individual units are then assembled into a plurality of groupings in at least one of the key frames. (block 1006) The groupings may be, for example, regularly or irregularly shaped clusters, rectilinear grid cells, or the like. In some invention embodiments, assembling the units in groupings may include assembling adjacent units having a similar surface normal into clusters. (e.g., FIG. 1, block 24 and corresponding discussion). In the case of a rectilinear grid, the grid may be of a predetermined size so that grid cell sizes are predetermined.

In the segmented key frames, each of the groupings is parameterized with an auxiliary coordinate system using the estimated surface orientation of the units in each of the groupings. (block 1008). This step of the example invention embodiment may include, for example, assigning coordinates to each image pixel to facilitate the realistic assignment of texture. Parameterizing may thereby include capturing the 3-dimensional location of points projected to individual pixels of the image, and assigning a 2-dimensional texture coordinate representation to the surface passing through these 3-dimensional points. The resulting 2-dimensional texture coordinates may also be referred to as an image distortion since each 2-dimensional pixel is ultimately assigned a 2-dimensional texture coordinate. This step may be consistent, for example, with that of block 26 of FIG. 1, although other steps are contemplated as will de described below.

In some (but not all) applications, performance of the step of block 1008 on all frames could lead to temporal “choppiness” or other visual inconsistencies. To reduce these effects, in some invention embodiments such as that illustrated in FIG. 8, the step of block 1008 is performed only on key frames. In other embodiments, however, this step could be practiced on additional frames. In essence, in some invention embodiments, all frames could be designated key frames. Referring again to the method of FIG. 8, block 1010 includes propagating the groupings and their auxiliary coordinate systems from the segmented key frames to the other frames is performed. This step is performed in a temporally consistent manner between frames. As used herein, the term “propagate” is intended to be broadly interpreted as meaning carry over, extend, spread, and the like.

Finally, texture is superimposed on each of the groupings in each of the frames (key and other frames). (block 1012). This step is performed using the auxiliary coordinate system of the groupings. The texture may be, for example, an image such as a photograph of an object, person, or the like, or may be a repeating pattern of shapes or the like. A result of practice of the steps of FIG. 8 is that the superimposed texture appears to move coherently with the underlying surface between images. This method can be useful, for example, to superimpose desired textures such as an image or a pattern of shapes over a three dimensional surface such as a video of a flag waving in the wind.

Further illustration of methods, program products, and systems of the invention will be provided below in discussing various additional embodiments of the invention useful for modifying a sequence of frames.

B.1 Modifying a Sequence of Image Frames: Texture Mapping

In another aspect of the present invention, methods, systems and program products generally consistent with the flowchart of FIG. 8 are directed to deforming a texture over the depiction of a shaded surface as it changes in a sequence of frames so that the texture image appears to follow the undulation of the surface between frames. For convenience, this method of the invention is referred to herein as “texture mapping.” An example application for texture mapping might be, by way of example, superimposing a texture image of a face over the front of a T-shirt as it undulates between frames in a videotape.

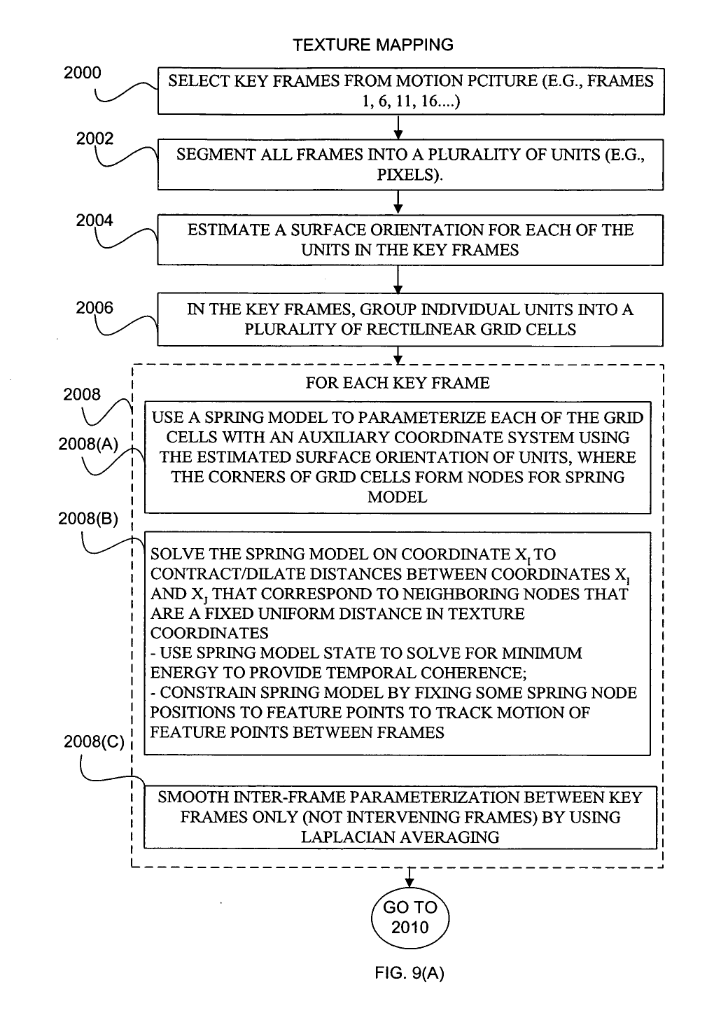

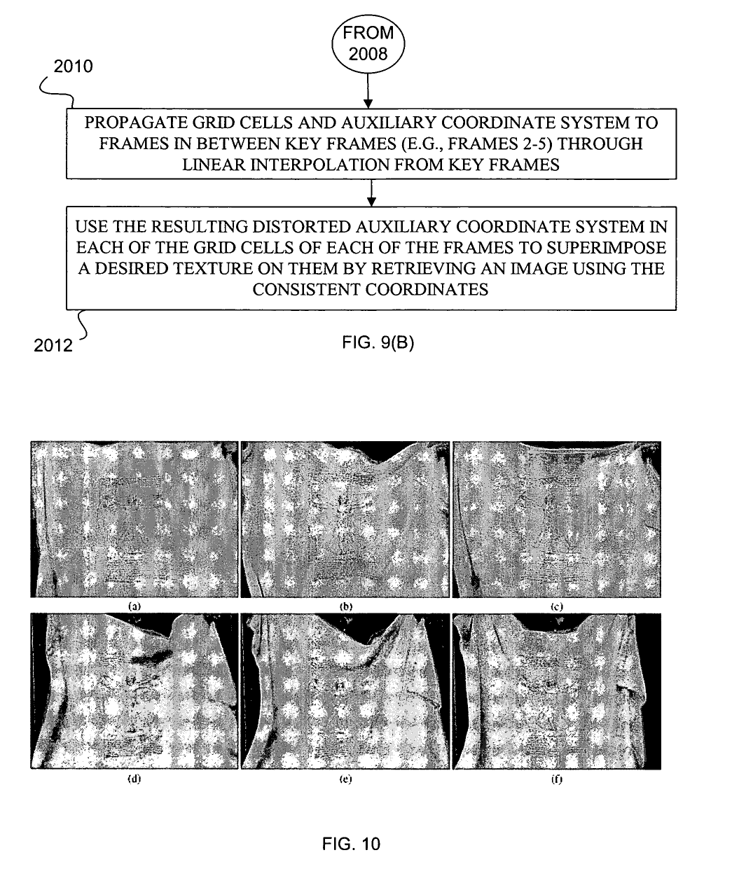

FIG. 9 illustrates an example “texture mapping” method of the invention. Because the steps of FIG. 9 are generally consistent with or are variations of the steps of the embodiment of FIG. 8, similar block numbers have been used in FIG. 9 in a “2000” series (e.g., step 2002 of FIG. 9 generally consistent with step 1002 of FIG. 8).

Referring now to FIG. 9, key frames are selected from the motion picture (block 2000). All frames (key and others) are then segmented into individual units, with an example being pixels or groups of pixels. (block 2002). A surface orientation for each of the units in the key frames is then estimated. (block 2004). In the key frames, units are then assembled into rectilinear grid cells, which may be, for example, square or rectangular. (block 2006).

In this texture mapping embodiment of the invention, steps of using a spring model are performed to parameterize the grid cells in the key frames with an auxiliary coordinate system. (block 2008). In previous embodiments of the invention that were directed to modification of only a single image (i.e., not a sequence), a similar deformation was achieved by propagating inter-unit (e.g., inter-pixel) distances to represent the distortion of foreshortening. These distances (and their orientations) were proximated across a small cluster of pixels with similar normals. In the current invention embodiment, however, the distances should be propagated across an entire texture image as opposed to individual clusters. It has been discovered that a spring model is useful to do so. For example, the spring network is useful to restrict the behavior of the propagation across the image, such that errors in the recovered normal and inconsistencies in the propagation are filtered out, yielding results that even if not entirely accurate appear plausible for a flexible surface.

FIG. 9 illustrates suitable steps for employing a spring model in a method of the invention. The spring model will be applied to key frames, and will use the surface orientation of each of the units. (block 2008(A)). The corners of the grid cells form nodes for use in the spring model. (block 2008(A)). The spring model is solved on coordinate X_{I} to contract or dilate distances between the coordinates X_{I} and X_{J} that correspond to neighboring nodes that are a uniform distance in texture coordinates. (block 2008(B)). The spring model is used to solve for the minimum spring energy. (block 2008(B)). This has been discovered to enhance temporal consistency between key frames.

It is also preferred to perform a step of constraining the spring model by fixing some spring node positions to feature points in the image. (block 2008(C)). Feature points are generally locations in the image that are easily recognized between frames. For example, in an image of a face, a feature point may be the corner of the eye, the nose tip, or a tooth corner. Feature points may be manually selected, or may be selected through an automated recognition process. A step of identifying a corresponding control point in the texture that corresponds to the location of each feature point may also be performed. The control point in the texture may then be fixed to the location of the feature point in the image. However, if only feature points are fixed in location and excluded from optimization visible distortions can result. To eliminate or reduce this, an additional step of limiting the deformation of a small area surrounding the control point may be performed so that the distortion is smoothed spatially.

A further step of smoothing inter-frame parameterization between key frames (i.e., on all key frames, but not on intervening frames) may be performed using smoothing techniques, with one example being Laplacian averaging. (block 2008(c)). The auxiliary coordinate system of the key frames is then propagated to the frames between the key frames. (block 2010) For example, if key frames are every 10^{th}, then the auxiliary coordinates are propagated to frames between every 10^{th} (e.g., 2-9, 11-19, etc.). Propagation can be carried out through any of several suitable steps, with one example being a linear interpolation. The auxiliary coordinate system is then used to superimpose a desired texture, such as a photographic image, by retrieving the image using consistent coordinates. (block 2012).

The steps of the example texture mapping embodiment of FIG. 9, including the steps of using a spring model, will be further described and illustrated through the following discussion. In this example texture mapping embodiment of the invention, a surface model is determined through the following steps. Assume a texture image T is selected to be superimposed on a surface image I. Let Uᵢ=(uᵢ, vᵢ) be one of a rectilinear 2-D grid of nodes evenly spaced across the texture image T. Let Xᵢ=(xᵢ, yᵢ) indicate the destination in the image I that texture image position Uᵢ will be mapped. Through embodiments of the present invention, image positions Xᵢ are found that appear to be spaced in a uniform rectilinear grid across the surface depicted in the image I, without explicitly reconstructing a 3-D model of the surface.

Let Nᵢ denote the surface normal recovered from the shading of image I at the position Xᵢ (which may be an individual pixel, for example). Let Xᵢⱼ=Xⱼ−Xᵢ be a vector from Xᵢ and the image position of a neighboring node Xᵢ, and let Nᵢⱼ=(Nᵢ+Nⱼ)/∥Nᵢ+Nⱼ∥ be the average normal of these two nodes. The vector Xᵢⱼ corresponds to the image projection of a vector on the surface denoted by P(Xᵢⱼ), which can be found using Nᵢⱼ and a derivation as described above (e.g., FIG. 1, block 22 and corresponding discussion). This surface vector P(Xᵢⱼ) is representative of Uᵢⱼ=Uⱼ−Uᵢ. Set Lᵢⱼ=∥Uⱼ−Uᵢ∥ to be the desired length of P(Xᵢⱼ). A desired outcome thus reduces to that of finding values of Xᵢ such that ∥P(Xᵢⱼ)∥=Lᵢⱼ.

It has been discovered that it is useful to minimize the total energy due to the spring energy between neighbors i and j:
Eᵢⱼ=Eⱼᵢ=(P(∥Xᵢ−Xⱼ∥)−lᵢⱼ)².
Because the solution positions {Xᵢ} influence the measurement of normals {Nᵢ}, the system is a non-linear least-squares problem, which can be solved by gradient descent.

Solutions may be determined with a degree of rigorousness as is desired and appropriate for a given application. In many cases, a coarse grid solution is appropriate, while in others a finer solution is desirable. At finer resolutions the total energy landscape E[{Xᵢ}]=ΣEᵢⱼ has many local minima that hinder global minimization. One method for avoiding these local minima embodiment of the invention, a surface model is determined through the following steps. Assume a texture image T is selected to be superimposed on a surface image I. Let Uᵢ=(uᵢ, vᵢ) be one of a rectilinear 2-D grid of nodes evenly spaced across the texture image T. Let Xᵢ=(xᵢ, yᵢ) indicate the destination in the image I that texture image position Uᵢ will be mapped. Through embodiments of the present invention, image positions Xᵢ are found that appear to be spaced in a uniform rectilinear grid across the surface depicted in the image I, without explicitly reconstructing a 3-D model of the surface.

Let Nᵢ denote the surface normal recovered from the shading of image I at the position Xᵢ (which may be an individual pixel, for example). Let Xᵢⱼ=Xⱼ−Xᵢ be a vector from Xᵢ and the image position of a neighboring node Xⱼ, and let Nᵢⱼ=(Nᵢ+Nⱼ)/∥Nᵢ+Nⱼ∥ be the average normal of these two nodes. The vector Xᵢⱼ corresponds to the image projection of a vector on the surface denoted by P(Xᵢⱼ), which can be found using Nᵢⱼ and a derivation as described above (e.g., FIG. 1, block 22 and corresponding discussion). This surface vector P(Xᵢⱼ) is representative of Uᵢⱼ=Uⱼ−Uᵢ. Set Lᵢⱼ=∥Uⱼ−Uᵢ∥ to be the desired length of P(Xᵢⱼ). A desired outcome thus reduces to that of finding values of Xᵢ such that ∥P(Xᵢⱼ)∥=Lᵢⱼ.

It has been discovered that it is useful to minimize the total energy due to the spring energy between neighbors i and j:
Eᵢⱼ=Eⱼᵢ=(P(∥Xᵢ−Xⱼ∥)−lᵢⱼ)².
Because the solution positions {Xᵢ} influence the measurement of normals {Nᵢ}, the system is a non-linear least-squares problem, which can be solved by gradient descent.

Solutions may be determined with a degree of rigorousness as is desired and appropriate for a given application. In many cases, a coarse grid solution is appropriate, while in others a finer solution is desirable. At finer resolutions the total energy landscape E[{Xᵢ}]=ΣEᵢⱼ has many local minima that hinder global minimization. One method for avoiding these local minima is to take a multiresolution approach by reducing the number of parameters over which to minimize the energy system. The texture mapping is reformulated as a piecewise affine warp controlled by a coarser grid of solution points {\hat{X}ⱼ}⊂{Xᵢ}, while the total energy is still computed at the finest resolution {Xᵢ}. This leads to a multiresolution relaxation where a solution found for a coarse grid is used as a starting point for a solution at a finer resolution. While a variety of stages of relaxation will be useful, it has been discovered that a two-stage relaxation is suitable in many applications where the solution of a coarse grid of 32×32 pixels per cell is used to initialize a solution on a finer grid of 6×6 pixels per cell.

By way of further describing an example step of applying a spring model to deform a texture surface, the following analogy may be useful. The texture may be considered to be a piece of soft cloth. The spring model is embedded into the texture “cloth” in a rectilinear pattern so that the cloth becomes elastic, similar to a rubber band. Then the texture cloth is “pasted” onto the undulating surface in the image. Since the texture is now elastic, it can be stretched in different ways while still keeping it on the surface. It is desired to find a most realistic way to paste this texture, so it appears to lie on the undulating surface with the least “stretch.”

Methods of the invention accomplish this by embedding springs as desired in the rectilinear grid of the texture. In one example, one spring is embedded between each neighboring pixel. It has been discovered, however, that solving on such a fine spring network doesn't converge well. To avoid this, example steps include solving he spring network on a sparser basis, with an example being one per every k nodes on the rectilinear positions. The spring node positions between solved nodes are linearly interpolated. Those nodes are then moved around in the image plane. From the recovered surface normal, an estimate can be made of how the springs are actually stretched on the surface, which in turn can be used to determine the elastic energy. The solver converges when such energy is minimized.

For a static image, the energy minimization produces a convincing distortion of an image texture so it appears to adhere to the underlying surface. For a coherent sequence of images, errors in temporal and spatial sampling, normal estimation and warp reconstruction can accumulate unwanted translation, rotation and other effects in the warp that cause the image to appear to “swim” on the underlying surface. To reduce or eliminate these unwanted effects, some methods of the invention include steps of estimating the motion of the surface between images, and of using the estimated motion to fix the positions of portions of the superimposed texture to corresponding locations on the image between frames.

One set of example steps for accomplishing this useful when practicing a texture mapping method of the invention includes fixing the position and orientation of the superimposed texture image on the surface through the identification and tracking of a minimal collection of feature points. Feature points may be manually selected, or may be selected through an automated recognition process. A step of identifying a corresponding control point in the texture that corresponds to the location of each feature point may be performed. The control point in the texture may then be fixed to the location of the feature point in the image. However, if only feature points are fixed in location and excluded from optimization visible distortions can result. To eliminate or reduce this, an additional step of limiting the deformation of a small area surrounding the control point may be performed so that the distortion is smoothed spatially.

Example steps of using feature points and control points may be further illustrated through the following illustration. Let Fₖ be a feature point, and let Xₖ be the control point associated with Fₖ. Then the added energy penalty incurred by Xₖ when it strays away from Fₖ is proportional to the distance
Eₖ=α∥Xₖ−Fₖ∥,
where the penalty strength may be set as desired, with an example value being 50.

It may also be useful to include a step of extending such constraint to a surrounding area or neighborhood {Xⱼ} of nodes near Xₖ, and of limiting the deformation of this neighborhood. One example set of steps to accomplish this includes finding the desired positions for the {Xⱼ} given that Xₖ should be at Fₖ. A separate optimization of the texture mapping can then be run using only a single feature point Fₖ, with the positions of the neighborhood nodes in this simulation {Xⱼ} recorded as {Fⱼ}. The positions of the {Xⱼ} in the original optimization are then penalized with multiple feature points toward these {Fⱼ}. The weights of these penalties should decrease gradually with distance from the original feature point Fₖ as
Eⱼ=αⱼ∥Xⱼ−Fⱼ∥,
where a Gaussian can be used to represent this decreasing penalty strength

$${α}_{j} = αexp ( \frac{- ‖ {F}_{k} - {F}_{j} ‖}{{σ}^{2}} )$$

where σ may be set as desired, with an example value being 25% of the distance between feature points.

Some methods of the invention also preferably include steps of performing temporal smoothing. Since each frame is computed independently except for the coherence of the feature points constraints, rapid changes in the recovered normal between frames can lead to inconsistencies and visual noise. As discussed above, steps of first parameterizing only key frames with an auxiliary coordinate system through independent calculation, and then applying linear or other interpolation to propagate the parameterization to frame between key frames have been discovered to reduce unwanted inconsistencies and visual noise. Other steps of temporal smoothing of the texture mapping in key and other frames can be useful to reduce or eliminate these problems. Many useful steps of temporal smoothing are contemplated, including the step of block 2008(C). Some will include measuring the change in position of each unit between two or more sequential images, and limiting this in some circumstance, such as when a sudden large movement occurs.

One example set of steps of smoothing includes applying a filter to smooth the deformed texture in key frames. Some suitable filters include terms relating individual unit positions in the deformed texture between sequential images and the distance the individual units move between sequential images. If movements are detected that are too sharp or that are otherwise temporally inconsistent, the filter may adjust the movement to make the deformation appear more temporally consistent. One suitable filter is a partial Laplacian filter for smoothing the texture mapping X(t)={Xi(t)} at frame t:

$$X ( t ) += \frac{1}{2} w ( X ( t - Δ t ) - 2 X ( t ) + X ( t + Δ t ) )$$

where the filter weight w may be set as desired, with an example being 0.1.

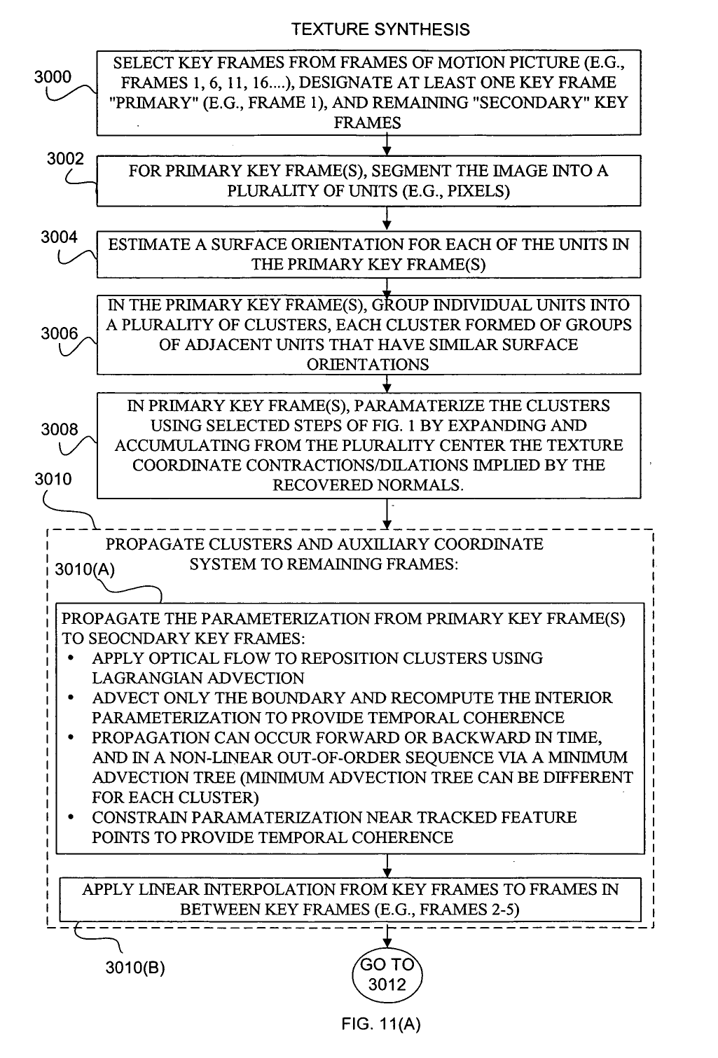

FIG. 10 is useful to further illustrate an example texture mapping method of the invention. In FIG. 10, the motion of a cloth is captured with a video camera. A texture image is pasted onto it using the steps described herein above. Three feature points are tracked on the surface and are used as constraints for the optimization to prevent the texture image from “swimming” on the surface. During optimization, five iterations are performed at 32 pixel control points spacing, then at 6 pixel spacing. The running time averages 110 seconds per frame.

B.2 Modifying Sequence of Frames: Texture Synthesis

Another example embodiment of the invention directed to modifying a sequence of images and consistent with FIG. 8 is useful to superimpose a texture on the images. In this embodiment, the superimposed texture may be a pattern of repeating shapes or images such as those illustrated in FIG. 2. One such embodiment of the invention is referred to as “texture synthesis,” since in this embodiment of the invention the superimposed texture will be grown or “synthesized” using a sample pattern as opposed to the mapping of the texture image that was performed in the above texture mapping embodiment.

This texture synthesis embodiment incorporates many of the steps of FIG. 1 to synthesize a texture on an image in a first frame of a sequence. In some texture synthesis embodiments, the steps of FIG. 1 are practiced on only key frames, and then the texture deformed by using the estimated surface between frames as outlined by the steps of FIG. 8. In other embodiments, every frame may be a key frame.

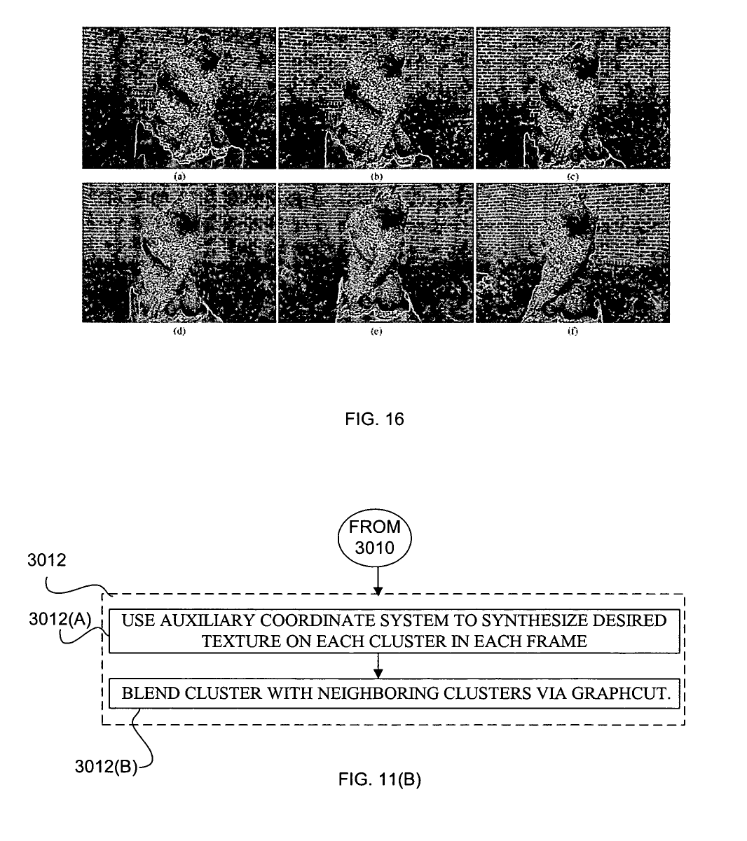

FIG. 11 illustrates an example “texture synthesis” method of the invention. Because the steps of FIG. 11 are generally consistent with or are variations of the steps of the embodiment of FIG. 8, similar block numbers have been used in FIG. 11 in a “3000” series (e.g., step 3002 of FIG. 11 generally consistent with step 1002 of FIG. 8).

Key frames from the motion picture of frames are first selected. (block 3000). Key frames may be, for example, every 3^{rd}, 5^{th}, 10^{th}, 25^{th}, or 50^{th} frame. In this example embodiment, at least one key frame is additionally designated as a primary key frame, with remaining key frames designated secondary key frames. The primary key frames are segmented into a plurality of individual units, with examples being pixels or groups of pixels. (block 3002). In some embodiments, all key frames are segmented into individual units. The surface orientation of each of the individual units in the segmented key frames (or in some embodiments, all key frames) is then estimated. (block 3004). This is preferably performed through steps of shape from shading to estimate a surface normal, as has been detailed herein above.

Adjacent of the individual units having similar surface orientations are then assembled into clusters. (block 3006). This step may be performed, for example, as described herein above with reference to block 24 of FIG. 1.

In the primary key frames, each of the clusters may then be parameterized with texture coordinates through steps as consistent with those of block 26 of FIG. 1 as described above, including the illustrations and discussion of FIG. 3. Generally, steps of expanding and accumulating from the center of the plurality of each cluster to the texture coordinate contractions/dilations that are implied by the recovered normals. Additional detail concerning these steps is provided herein above with reference to similar steps of FIG. 1.

The auxiliary coordinate system and clusters of the primary key frames are then propagated to the secondary key frames and to the non-key frames (block 3010). With regard to secondary key frames, this is accomplished through applying optical flow to reposition clusters, preferably through Laplacian advection. (block 3010(A). In order to enhance temporal consistency, only cluster boundaries are advected, and the cluster interior is reparameterized. (block 3010(A)). It has been discovered that use of a minimum advection tree that can progress in a non-linear, out-of-order sequence, forward or backward in time can offer benefits. Also, reparameterization in regions close to tracked feature points is constrained to further enhance temporal coherence.

Some aspects of the steps of block 3010(A) are further detailed as follows. Simple optical flow algorithms usually match sparse features between two video frames and interpolate this matching into a smooth dense vector field. Other more complex and sophisticated optical flow methods are known and will be useful in practice of embodiments of the invention. The quality of optical flow depends on the distribution and accuracy of feature points. The criterion for a feature point can be relaxed until every pixel becomes a feature and the optical flow is a least-squares deformation from one image to the next. In any case, optical flow methods taken alone are not accurate enough to be able to deform the color signal produced by a texture synthesized or mapped in the first frame to frames in the remainder of a sequence. Steps of optical flow, however, can yield satisfactory results when incorporated within methods of the invention.

Steps of performing an optical flow, for instance, can be useful to reposition clusters between images. Because optical flow methods are generally known, detailed description herein is not necessary. The following summary is provided, however, of optical flow steps that are useful within practice of the invention. An optical flow O_{t0→t1}: (x, y)→(Δx, Δy) is a two dimensional velocity field of two-vectors that describes for each pixel (x, y)ε(t₀) its location (x+Δx, y+Δy) in a new frame I(t₁).

A number of techniques exist for recovering an optical flow from a video sequence. Since steps of the invention have already organized the image into clusters corresponding to space-coherent surface patches, a coarse approximation of the optical flow generated from a relatively small number of feature points is suitable. Let Fⱼ(t) indicate the position (x, y)ε(t) in the frame at time t of feature point j. The motion of these feature points ΔFₖ(t)=Fₖ(t+Δt)−Fₖ(t) yields a sparse 2-D vector field that when interpolated (for example, by using multilevel free form deformation) generates a coarse but adequate approximation of the optical flow.

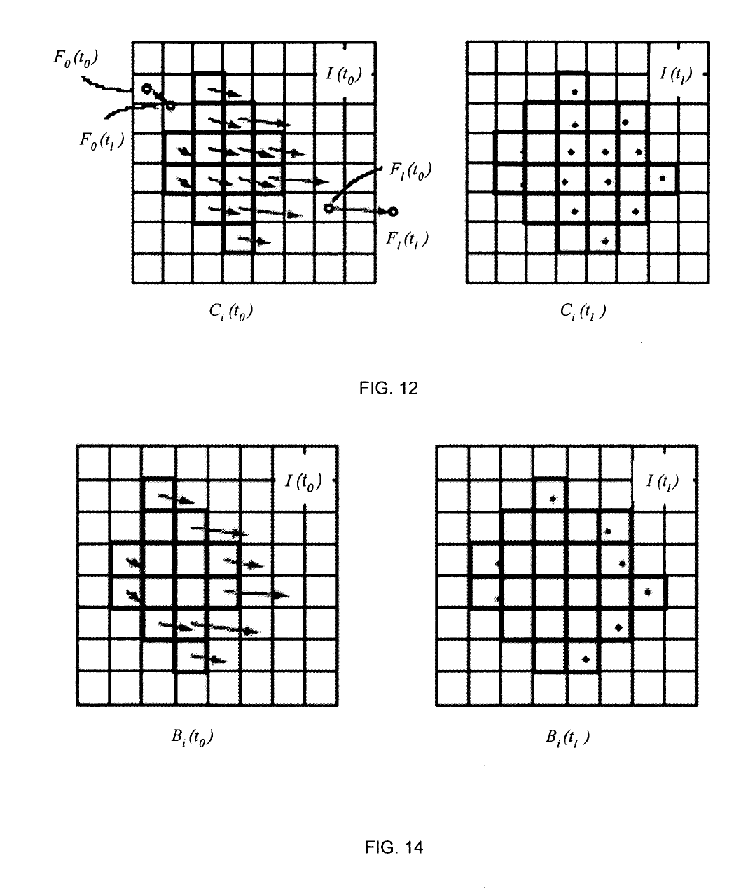

This is illustrated by FIG. 12. Optical flow (arrows left) interpolated from feature points F₀ and F₁ (circles left) are used to advect cluster pixels Cᵢ(t₀) into positions (dots, right) interpolated into a new cluster Cᵢ(t₁). As illustrated by FIG. 12, the pixels in clusters Cᵢⱼ(t) are moved through Lagrangian advection under the optical flow O_{t0→t1} into the image I(t₁). The new cluster pixel positions O_{t0→t1} (Cᵢⱼ(t₀)) in general do not fall on pixel centers, so pixels in I(t₁) are classified into the cluster Cᵢⱼ0 (t₁) by their nearest neighbor O_{t0→t1} (Cᵢⱼ(t₀)).

Practice of steps of optical flow can be complicated when portions of a moving surface appear and disappear as the surface moves between image frames due to occlusion. In such cases optical flow advection alone cannot manage the disappearance and reappearance of a cluster corresponding to a given portion of the surface. In these cases, it is preferred to perform steps of non-linear optical flow and cluster advection. As used in this context, the term non-linear is intended to be interpreted as meaning out of time sequence. For example, a nonlinear optical flow advection of sequential image frames 1, 2, 3, 4 and 5 may follow the course 3, 2, 1, 4 and 5. Each cluster is constructed and parameterized in the frame where it most squarely faces the camera. The cluster can then advect and propagate its parameterization to the rest of frames.

The minimum advection tree (MAT) is a directed graph that indicates for each frame the frames other than itself and its parent that are more similar to it than any other. Some methods of the invention include steps of building a MAT and using it with steps of optical flow. After construction of a MAT, steps of computing optical flow are performed, followed by cluster advection and reparameterization from the root of the MAT to its leaves in an order that prioritized spatial instead of temporal coherence (e.g., frames at two different times may be very similar).

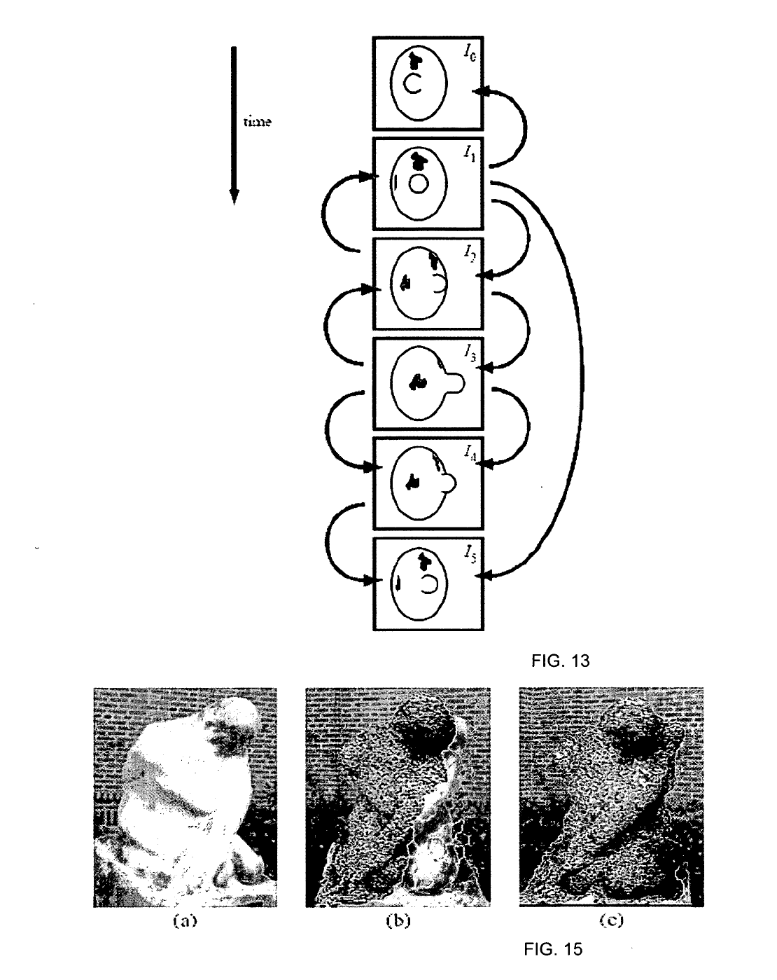

FIG. 13 is useful to illustrate example steps of building a MAT. In particular, FIG. 13 illustrates a MAT for two clusters in a six frame video that schematically illustrate a head turning. Two clusters are schematically illustrated: the “uppermost” cluster shown in frames I₀-I₃ and I₅ (on the “forehead”), and the more centrally located cluster shown in frames I₁-I₅ (on the “cheek”). The uppermost cluster in frames I₀ and I₅ is advected from the uppermost cluster root frame I₁ where it appears to be closest to directly facing the camera. This is indicated by the direction arrows shown along the right side of FIG. 13. The more centrally located cluster does not even appear in the first frame of the video. This cluster is advected from the root frame I₃, where it appears to be closest to directly facing the camera. Advection path for this cluster is illustrated by the direction arrows along the left side of FIG. 13. FIG. 14 that illustrates various views of a statue taken about an arcing path is useful to further illustrate advection. Parts of the statue are not visible from its initial pose (a). New clusters are generated at a later moment (b) as the camera moves about the statute and its surface “rotates” in the image frames and are advected with MAT to cover the whole surface (c).

In some applications it may be useful to build a separate MAT for each cluster, and then advect each cluster independently. MAT's for different clusters in each frame may differ, may be non-linear, and may move forward or backward in time. This individual processing of clusters, however, in some applications can be computationally expensive and memory incoherent. In these cases it may be preferred to group clusters facing similar direction and process these “superclusters” together.

Also, a “collision” in cluster shape can occur when two different cluster advection paths lead to frames neighboring in time, and the accumulated error due to the different optical flows of the two paths causes a cluster to advect into different shapes. One method step for smoothing such collisions is to advect the cluster from one path backwards through the history of the other path and averaging the shapes. Other steps of smoothing may be practiced in these circumstances, including interpolation to correct collisions, or blending the collided clusters into one another near the collision.

Steps of assigning costs to all advections may be practiced. For example, the cost of the jump advection to non-neighboring frames can be assigned at some premium, with an example being four times, compared to advection between neighboring frames to reduce “collisions.” Thus advection to a non-neighboring frame is only practical for distances larger than four frames in the past or future. Under this constraint, most video yields a MAT structure consisting of a few long time-linear sequences. To build a MAT rooted at a certain frame, any other frame is linked to that frame through a series of advections with lowest cost.

Referring once again to the flowchart of FIG. 11, once the auxiliary coordinate system has been propagated to the secondary key frames, it is likewise propagated to the non-key frames. (block 3010(B)). This is accomplished through any of many suitable steps, with an example being a linear interpolation. The auxiliary coordinate system is then used to synthesize a desired texture on each cluster of each frame (key and non-key) (block 3012(A)). An optional step of blending the clusters together may be performed if desired to provide enhanced visual consistency (block 3012(B)). This can be performed through steps of expanding each of the clusters whereby they overlap onto adjacent of one another. The texture patches are then blended together by identifying a visually plausible seam between adjacent of said texture patches in an overlapping region between adjacent of the texture patches. This may also be accomplished through the steps of the graphcut method as discussed in detail above.

Various aspects of the method of FIG. 11 will be further discussed to provide further illustration of one example embodiment of the invention. In some general aspects, the method of FIG. 11 may be thought of as including performing the method of FIG. 1 on primary key frames, and then propagating the resulting auxiliary coordinate system to other frames. Under this framework of consideration, some further description is appropriate. Recall that the steps of FIG. 1 clustered pixels of similar recovered normal to reduce variation within each cluster and thereby reduce error when propagating texture coordinates from the cluster center to its boundary. But a dynamic surface that is moving between images will yield different recovered normal fields leading to a different arrangement of clusters from image frame to image frame.

To address this, some texture synthesis methods of the invention assume the depicted surface, while dynamic, undergoes a motion that is mostly rigid-body and otherwise deforms in a subtle and localized manner. For example, the motion of a face follows the orientation of the rigid-body head but also contains expression that tends to be less rigid-body and includes more flowing motion. Some methods of the invention adopt this approach by assuming clusters to correspond to patches on the surface, and though their image may move and change size, the relative shape and organization of clusters should remain consistent during surface motion. Put another way, the seams of the clusters can be held constant relative to their position on the underlying image between some sequential images, or the texture coordinates of the cluster boundaries may be held constant.

The method of FIG. 1 clustered pixels in a still image by like normal. Let Cᵢⱼ denote the pixels 0≦j<|Cᵢⱼ| in cluster i. For each cluster i, let Uᵢ: (x, y)→(u, v) describe the parameterization generated by the steps of FIG. 1 and for that cluster that distorts the synthesized texture according to the foreshortening derived from the recovered surface normals. When applied to a sequence of video frames, the recovered normals of a dynamic surface change, and the clusters they yield may not correlate with clusters from neighboring frames.

The application of the clustered texture synthesis resulting from FIG. 1 to a sequence of image frames (e.g., to a motion picture such as a video) requires the construction of a time-coherent clustering. One example set of steps for doing so is use of an optical flow to advect clusters, which allows the clusters to evolve as the surface and view evolve while retaining their grouping of like normals in a temporally coherent manner, as shown in block 3010(A) and discussed above.

Texture synthesis methods may also include steps of cluster reparameterization. As explained above, steps of optical flow advection can be used to propagate the pixel clusters from one frame to another. In the example method embodiment of FIG. 11, the steps are used to propagate the auxiliary coordinates from the primary key frames to secondary key frames. In other method embodiments, these steps can be used to propagate to all other frames (e.g., all remaining frames are secondary key frames). Also, in the example method of FIG. 11, only a subset of the cluster, for example, its boundaries or the seams created during the step of block 3008 (e.g., graphcut as discussed above) may be propagated to enhance time coherence. After propagation, the secondary key frame then contains clusters that can be reparameterized to reflect the foreshortening distortions of its new field of recovered surface normals. The methods described herein with respect to modifying a single image, with an example being that of FIG. 1, propagate a parameterization from a cluster center to its boundary, so the texture coordinates generated on the boundary of a cluster in a new sequential image frame with its new normals can differ significantly from the coordinates generated on the cluster's boundary in the previous image frame. Since the cluster boundary desirably blends nicely with the neighboring cluster, changes in texture at the boundary are particularly noticeable.

One embodiment of the present invention uses a method for modifying a single image, such as that described by FIG. 1 and corresponding discussion, on clusters in the starting frame and find the best seams in the overlapping region between neighboring clusters to blend them together in a visually plausible manner. One example set of steps for doing so is via the Graphcut method described herein above. The goal is to reparameterize a cluster in a subsequent image frame while retaining its original texture coordinates along this seam. This maintains the color match between overlapping clusters during advection.

FIG. 14 shows boundary pixels at time t₀ (shaded left) advect into positions at time t₁ (dots right) that preserve their texture coordinates, which are then resampled to correct the texture coordinates of boundary pixels Bᵢ(t₁) and eventually the entire cluster Cᵢ(t₁).

Following are example steps for accomplishing a reparameterization. Let Bᵢⱼ(t)⊂Cᵢ(t) be the pixels, indexed by 0≦j<||Bᵢⱼ(t)|, on the seam of cluster i at time t. Steps of optical flow are applied to advect cluster Cᵢ(t₀) to Cᵢ(t₁) and this advection takes each boundary pixel Bᵢⱼ∈Cᵢ(t₀) to the position Oₜ_{_{0→}}ₜ_{₁}(Bᵢⱼ) in the frame at t₁. A parameterization correction vector is then defined for each of these points j in each cluster i as
ΔUBᵢⱼ=U(Bᵢⱼ)−U(Oₜ_{₀}_{→t}_{₁}(Bᵢⱼ)),
the difference in the desired texture coordinate of the original cluster boundary pixel U∘Bᵢⱼ and the texture coordinate generated by the method of FIG. 1 and corresponding discussion using the new normal field U∘O_{t0→t1}(Bᵢⱼ). Since O_{t0→t1}(Bᵢⱼ) may not correspond to a pixel center in I(t₁), its texture coordinates U(O_{t0→t1}(Bᵢⱼ)) may need to be interpolated from the texture coordinates of its nearest four pixels in Cᵢ(t₁). It has been discovered that nearest neighbor interpolation is sufficient in most applications.

Likewise, the feature points Fₖ(t) that generate the optical flow were selected based on ease of visual identification in each image frame. While it is desirable to prevent the appearance of texture swimming at any point on the displayed surface, it is also especially desirable to avoid deviations in the texture at these feature points. Steps of accomplishing this include defining a parameterization correction vector for the feature points as
ΔUFₖ=U(Fₖ(t₀))−U(Fₖ(t₁)),
the difference between the original desired texture coordinates of a feature point from frame t₀ and the texture coordinates generated by the new normal field at frame t₁.

The parameterization Uₜ₁ generated by the surface normals Nₜ₁ recovered from I(t₁) may be corrected using a correction field constructed by interpolating the boundary and feature parameterization correction vectors. Let ΔUₜ₁: (x, y)→(Δu, Δv) be the parameterization correction field constructed by interpolating the sparse correction vectors ΔU Bᵢⱼ and ΔU Fₖ. This field corrects the parameterization at frame t₁ as:
Uₜ_{₁}+=ΔUₜ_{₁}.
The parameterization correction terms are applied at the expense of the magnitude of the effect of foreshortened texture distortion. While the human perceptual system uses texture in part to resolve perspective, small errors on a non-simple surface can be perceptually insignificant, and in any case are a rather small price to pay for the more critical effect of temporal coherence of texture features.

Like other methods of the invention, texture synthesis methods may also include steps to enhance temporal smoothing. Clustered texture synthesis, even when corrected by locking the texture coordinates at boundary pixels and feature points can in some cases still appear noisy because the normal field upon which they are built is not temporally smooth. Steps of some embodiments of methods of the invention (such as those of FIG. 11) stabilize the synthesized texture on the perceived surface by restricting the texture reparameterization and correction process to key frames and interpolating the texture coordinates for the intermediate frames. This reduces oscillations and they more subtly blend into the actual motion of the surface. Since the texture clusters are advected every frame from an optical flow constructed from feature points and the per-cluster texture parameterization is interpolated between key frames, the reconstructed normal field directly influences the texturing of the key frames, but does not directly influence the clustering and parameterization of the intermediate frames.

Steps of rendering may also be practiced. Image brightness can be used to modulate the diffuse reflection of the synthesized texture. The synthesized texture is rendered with a specular reflection based on the synthesized texture's normal oriented relative to the recovered normal field. Optimal seams can be identified between clusters manually or through other steps, including use of the graphcut method discussed above in an initial frame. Subsequent frames retain this seam because the texture coordinates of cluster boundaries are retained during advection. In some cases it may be useful to further execute a 3-D extension of the graphcut method over the time-space volume of clusters to improve this boundary, using, for example, a roughly six-pixel-wide region surrounding the original advected seam.

FIG. 16 illustrates the results of practice of a method of the invention on the statue illustrated in FIG. 15. The statue is scanned with a handheld video camera, with FIG. 16 showing three frames from video frames shot as the camera circled the statue along an arc path. Most of the clusters are visible in the first frame of FIG. 16, where they are defined and parameterized, and advected in forward time order as a single supercluster. The clusters not visible in the first frame are defined and parameterized in the final frame, and advected again as a single supercluster, in reverse time order. The synthesis is run twice for two those superclusters, and the overall synthesis time is 59.5 seconds per frame.

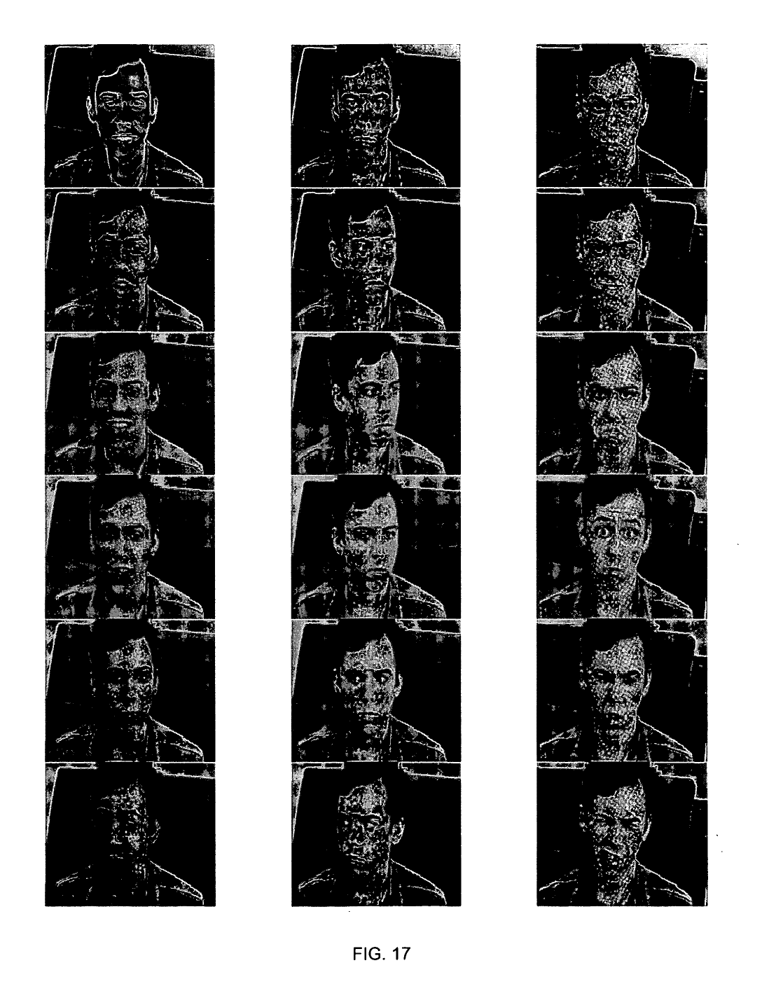

FIG. 17 is likewise useful to illustrate practice of a texture synthesis embodiment of the invention. In FIG. 17, a total of 27 feature points are located and tracked on the face as shown in the first sequential image. Some are automatically placed and tracked at easily detectable features while others are manually placed and tracked on smooth but important locations, such as cheeks and nose tip. The optical flow is generated from these feature point correspondences by a free form deformation field. The absolute accuracy in the locations of the feature points is not essential, but jumps in their locations can generate high frequency oscillation in the resulting texture. The location of the feature points was smoothed using the partial Laplacian filter described above (see equation for X(t) above).

FIG. 17 demonstrates that methods of the invention, and a texture synthesis embodiment in particular, handle large face deformation and rotation robustly. In the rotating face sequence shown in the center column, the clusters are grouped into three superclusters at different stages of the rotation. Each supercluster is synthesized independently and their results are merged.

Methods, systems and program products of the present invention for texturing an animated surface eliminate the need for accurate optical flow and full shape from shading methods. The texture synthesis embodiment of the invention discussed above provides the useful results illustrated in FIG. 17 using only about 30 feature points and inaccurate, locally recovered normals that assume a simple Lambertian reflection. Multiple cameras, calibration, and/or multiple light sources are not required—the invention may be practiced on video images shot from a single un-calibrated camera without precise knowledge of the location of the light source.

It will be understood that although exemplary embodiments of the invention have been discussed and illustrated herein as methods, other embodiments may comprise computer program products or systems. For example, an exemplary embodiment of the invention may be a computer program product including computer readable instructions stored on a computer readable medium that when read by one or more computers cause the one or more computers to execute steps of a method of the invention. Methods of the invention, in fact, are well suited for practice in the form of computer programs. A system of the invention may include one or more computers executing a program product of the invention and performing steps of a method of the invention. Accordingly, it will be understood that description made herein of a method of the invention may likewise apply to a computer program product and/or a system of the invention. It will further be understood that although steps of exemplary method embodiments have been presented herein in a particular order, the invention is not limited to any particular sequence of steps.

What is claimed is:

1. A method for modifying a sequence of a plurality of frames depicting a surface comprising the steps of:
selecting at least one key frame from the plurality of frames;
segmenting the surface in said at least one key frame into a plurality of units;
estimating a surface orientation of each of said units in each of said at least one key frames;
assembling said units in each of said at least one key frame into a plurality of groupings;
using said surface orientation of said units to parameterize each of said groupings with an auxiliary coordinate system;
propagating said groupings and said auxiliary coordinate system from said at least one key frame to others of the plurality of frames whereby said auxiliary coordinate system models movement of the surface in a time coherent manner between frames; and,
using said auxiliary coordinate system in each of said groupings in each of said frames to superimpose a texture on the depicted surface whereby said texture appears to change temporally consistently with the depicted surface between the plurality of frames.

2. A method for modifying a sequence of frames as defined by claim 1 wherein the step of estimating said surface orientation of each of said units comprises using the shading of the surface to estimate said surface orientation.

3. A method for modifying a sequence of frames as defined by claim 2 wherein the step of using the shading of each of said units further comprises estimating a surface normal for each of said units.

4. A method for modifying a sequence of frames as defined by claim 3 wherein the step of estimating a surface normal for each of said units comprises the steps of:
assuming that said individual unit of said at least one image having the largest intensity Iₘₐₓ faces a light source and that said individual unit of said at least one image that is the darkest has an intensity Iₘᵢₙ that represents ambient light;
estimating a cosine c(x, y) for the angle of incidence as:
$$c ( x , y ) = \frac{( I ( x , y ) - {I}_{min} )}{( {I}_{max} - {I}_{min} )}$$
estimating a sine for the angle of incidence as:
s(x, y)=\sqrt{1−c(x, y)²}
using said estimated sin and cosine to estimate a normal N(x ,y):
$$G ( x , y ) = ∇ I ( x , y ) - ∇ I ( ( x , y ) \cdot S ) S$$
$$N ( x , y ) = c ( x , y ) S + \frac{s ( x , y ) G ( x , y )}{‖ G ( x , y ) ‖}$$
$$where$$
$$∇ I ( x , y ) = ( \frac{\partial I}{\partial x} , \frac{\partial I}{\partial y} , 0 )$$
is the image gradient.

5. A method for modifying a sequence of frames as defined by claim 1 wherein said at least one key frame comprises a plurality of key frames separated from one another by others of the plurality of sequential frames, and wherein the step of propagating said groupings and said auxiliary coordinate system from said plurality of key frames to remaining of the plurality of frames comprises applying an interpolation between said key frames.

6. A method for modifying a sequence of frames as defined by claim 1 and further including the steps of identifying a plurality of feature points on the surface, tracking the motion of said feature points between the plurality of frames, and constraining said auxiliary coordinate system in a region proximate to said feature points whereby movement of said texture between frames appears to be temporally coherent in said regions.

7. A method for modifying a sequence of frames as defined by claim 1 wherein said at least one key frame comprises a plurality of key frames separated from one another by at least four of the remaining frames.

8. A method for modifying a sequence of frames as defined by claim 1 wherein said plurality of groupings comprises a plurality of rectilinear grid cells, and wherein the step of using said surface orientation to parameterize each of the groupings further comprises using a spring model, corners of said rectilinear grid cells forming nodes for said spring model.

9. A method for modifying a sequence of frames as defined by claim 8 wherein said at least one key frame comprises a plurality of key frames, and wherein the step of using said spring model comprises:
solving for the minimum energy of said spring model between said plurality of key frames to provide temporal consistency in said key frames;
tracking motion of feature points on said surface between said plurality of key frames; and,
constraining said spring model by fixing some spring model node positions to at least some of said feature points in each of said key frames.

10. A method for modifying a sequence of frames as defined by claim 1 wherein said texture comprises an image.

11. A method for modifying a sequence of frames as defined by claim 1 wherein the step of assembling said units into groupings comprises assembling adjacent of said units having similar surface orientations into clusters.

12. A method for modifying a sequence of frames as defined by claim 1 wherein the step of propagating said groupings and said auxiliary coordinate system from said at least one key frame to remaining of the plurality of frames comprises identifying a plurality of feature points on the surface, and using the movement of said feature points between the frames to apply optical flow to said groupings using an advection.

13. A method for modifying a sequence of frames as defined by claim 1 wherein said at least one key frame comprises a primary key frame, wherein the method further includes designating a plurality of secondary key frames, and wherein the method further includes the step of identifying a plurality of feature points on the surface, tracking the motion of said feature points between said primary and secondary key frames, using the movement of said feature points between said primary and secondary key frames to apply optical flow to said groupings using an advection.

14. A method for modifying a sequence of frames as defined by claim 13 wherein the step of applying optical flow and advection further comprises creating a non-linear minimum advection tree of said primary and secondary key frames, and using said non-linear minimum advection tree to apply said optical flow to said groupings.

15. A method for modifying a sequence of frames as defined by claim 14 wherein each of said groupings have a border, and wherein the step of applying said optical flow and advection comprises advecting only a portion of said grouping proximate to said boundaries and re-parameterizing the remaining portion of said grouping with said auxiliary coordinate system to achieve temporal consistency.

16. A method for modifying a sequence of frames as defined by claim 14 and further including using an interpolation to propagate said auxiliary coordinate system to frames between said primary and secondary key frames.

17. A method for modifying a sequence of frames as defined by claim 1:
wherein said groupings comprise clusters of adjacent units having similar surface orientations;
wherein said auxiliary coordinate system comprises a texture coordinate system, wherein the step of using said surface orientation of said units to parameterize each of said groupings with an auxiliary coordinate system comprises parameterizing each of said plurality of clusters with texture coordinates; and,
wherein the step of using said auxiliary coordinate system superimpose a texture comprises using said texture coordinates to create a texture patch corresponding to each of said clusters and blending said texture patches together to define said deformed texture.

18. A method for modifying a sequence of frames as defined by claim 1:
wherein said groupings in said key frame comprise clusters of adjacent units having similar surface orientations;
wherein said auxiliary coordinate system in said key frame comprises a texture coordinate system, wherein the step of using said surface orientation of said units to parameterize each of said groupings with an auxiliary coordinate system comprises parameterizing each of said plurality of clusters with texture coordinates; and,
wherein the step of using said auxiliary coordinate system to superimpose a texture comprises using said texture coordinates to create a texture patch corresponding to each of said clusters and blending said texture patches together to define said deformed texture.

19. A method for modifying a sequence of frames as defined by claim 1 wherein said groupings comprise clusters of adjacent of said units having similar surface orientations, and wherein the step of using said auxiliary coordinate system in each of said groupings in each of said frames to superimpose a texture on the surface further comprises:
expanding each of said clusters whereby they overlap onto adjacent of others of said clusters; and,
blending said texture superimposed on each of said clusters into texture superimposed on other of said clusters by identifying a visually plausible seam between texture on adjacent of said clusters in an overlapping region between said adjacent clusters.

20. A computer program product comprising computer executable instructions stored on a computer readable medium for modifying a temporal sequence of frames in a motion picture that depicts a three dimensional surface moving between the frames, the instructions capable of being executed by one or more computers, the executable instructions when executed causing the one or more computers to carry out the steps of:
select a plurality of key frames from the plurality of sequential frames, said key frames separated from one another by at least three sequential frames;
segment the surface in each of said key frames into a plurality of units;
use the shading of each of said unites in each of said key frames estimate a surface orientation of each of said units in each of said at least one key frames;
assemble said units in each of said at least one key frame into a plurality of groupings;
use said surface orientation of said units to parameterize each of said groupings with an auxiliary coordinate system;
use a linear interpolation to propagate said groupings and said auxiliary coordinate system from said at least one key frame to others of the plurality of frames whereby said auxiliary coordinate system models movement of the surface in a time coherent manner between frames;
identify a plurality of feature points on the surface, track the motion of said feature points between the plurality of frames, constrain said auxiliary coordinate system in a region proximate to said feature points whereby movement of said texture between frames appears to be temporally coherent in said regions; and,
use said auxiliary coordinate system in each of said groupings in each of said frames to superimpose a texture on the surface whereby said texture appears to change temporally consistently with the surface between the plurality of frames.
